(19) United States
(12) Patent Application Publication
(10) Pub. No.: US 2025/0043971 A1
(43) Pub. Date: Feb. 6, 2025

(54) LATENT ENERGY AND WATER HARVESTING SYSTEM

(71) Applicant: Montana Technologies LLC, Ronan, MT (US)

(72) Inventors: Daniel Albert GABIG, Polson, MT (US); Matthew Bernard JORE, Ronan, MT (US); James Douglas JORE, Polson, MT (US); Michael Alan KVAM, Polson, MT (US); Hector RUIZ, Brunswick, GA (US); Jeromy W J JENKS, Hines, OR (US); Tristram Charles Raglan BRACEY, West Sussex (GB)

(21) Appl. No.: 18/697,144

(22) PCT Filed: Sep. 30, 2022
(86) PCT No.: PCT/US22/77316

§ 371 Date: Mar. 29, 2024

Related U.S. Application Data
(60) Provisional application No. 63/251,078, filed on Oct. 1, 2021.

(51) Int. Cl. F24F 5/00; E03B 3/28; F24F 13/22

(52) U.S. Cl. CPC F24F 5/0014; E03B 3/28; F24F 13/222

(57) ABSTRACT

In one embodiment, a method (236) of harvesting thermal energy and water from air, the method comprising: receiving a flow of water vapor containing air over a first heat exchanging contactor contained in a chamber in a non-sealed state, the first heat exchanging contactor coated with an adsorbent material that adsorbs water vapor (238); desorbing water vapor from a second adsorbent-coated heat exchanging contactor contained in a chamber in a sealed state under a partial vacuum (240); exchanging thermal energy between the first heat exchanging contactor and the second heat exchanging contactor, wherein heat gained by heat of adsorption in the first heat exchanging contactor transferred to heat the second heat exchanging contactor to aid desorption, wherein heat lost due to the heat of desorption in the second heat exchanging contactor is transferred to cool the first heat exchanging contactor to aid adsorption (242); drawing a vacuum in the sealed chamber to pull air out and desorb, compress, and heat the water vapor (244); condensing water vapor in a condenser under a partial vacuum (246); recovering heat of condensation and liquid condensate from the water vapor in the condenser (248); and repeating the method with the first heat exchanging contactor used for desorbing in a sealed-state and the second heat exchanging contactor used for adsorbing in a non-sealed state (250).

### CROSS-REFERENCE TO RELATED APPLICATIONS

This application is a 371 National Phase application of PCT/US22/77316, filed Sep. 30, 2022, which claims the benefit of U.S. Provisional Application No. 63/251,078 filed Oct. 1, 2021, the entirety of which is incorporated by reference herein.

### TECHNICAL FIELD

The present disclosure is an ultra-efficient atmospheric energy and water harvesting system that enables a substantial reduction of electrical power required to provide potable water and thermal energy from air for beneficial use in heating, cooling, and air conditioning applications.

### BACKGROUND

Water scarcity around the world affects billions of people, and heatwaves due to global warming impact billions more. As the earth continues to warm, the need for air conditioning is expected to triple in the next three decades. Currently, air conditioning and water systems comprise the largest single power demand in buildings, accounting for approximately 47% of total energy use globally. Air conditioning also puts a huge drain on electric vehicle (EV) batteries, which can reduce driving range by as much as 75%. For instance, an electric bus driven in congested traffic may consume more energy from the battery for cooling the cabin than the power train uses to propel the vehicle.

Traditional air conditioning systems remove humidity from air by lowering the temperature of the air to below dewpoint by utilizing cooling with evaporator coils. For instance, humidity of the incoming or recirculated air is drawn out by the evaporator in a conventional, refrigerant based cooling system (e.g., the evaporation of the liquid refrigerant inside the coil that pulls heat out of the air flowing over the coil). When the air is cooled and thence becomes saturated, the water vapor condenses on the surface of the evaporator. The condensation of water vapor releases latent heat to the coil, which thermal energy is transferred to the refrigerant, leaving less capacity to take away sensible heat from the airflow (e.g., less ability to lower the air temperature). The water droplets also physically impede the airflow through the coil. The way this has been managed in the past has been to make the system larger so that the system is able to dew out the water vapor and still have enough remaining capacity to cool the air stream. In humid climates, the water vapor condensing on the evaporator cools, and releasing the heat of condensation accounts for 60% or more of the total thermal energy that the system must overcome to cool the air in the building or vehicle. This results in, among other issues, oversizing of the air conditioning condenser and evaporator heat exchangers and the refrigerant compressor, which wastes energy, adding to greenhouse gas emissions.

### SUMMARY OF THE INVENTION

In one embodiment, a method of harvesting thermal energy and water from air, the method comprising: receiving a flow of water vapor containing air over a first heat exchanging contactor contained in a chamber in a non-sealed state, the first heat exchanging contactor coated with an adsorbent material that adsorbs water vapor; desorbing water vapor from a second adsorbent-coated heat exchanging contactor contained in a chamber in a sealed state under a partial vacuum; exchanging thermal energy between the first heat exchanging contactor and the second heat exchanging contactor, wherein heat gained by heat of adsorption in the first heat exchanging contactor transferred to heat the second heat exchanging contactor to aid desorption, wherein heat lost due to the heat of desorption in the second heat exchanging contactor is transferred to cool the first heat exchanging contactor to aid adsorption; drawing a vacuum in the sealed chamber to pull air out and desorb, compress, and heat the water vapor; condensing water vapor in a condenser under a partial vacuum; recovering heat of condensation and liquid condensate from the water vapor in the condenser; and repeating the method with the first heat exchanging contactor used for desorbing in a sealed-state and the second heat exchanging contactor used for adsorbing in a non-sealed state.

These and other aspects of the invention will be apparent from and elucidated with reference to the embodiment(s) described hereinafter.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present systems and methods. Moreover, in the drawings, like reference numerals designate corresponding parts throughout the several views.

FIG. 1 is a schematic diagram illustrating one embodiment of a latent energy and water harvesting system.

FIGS. 2A-2C are schematic diagrams illustrating an example tube and fin heat exchanging contactor.

FIGS. 3A-3C are schematic diagrams illustrating an example microchannel heat exchanging contactor.

FIG. 4 is a schematic diagram illustrating one embodiment of a door mechanism to seal a desorbing chamber of a latent energy and water harvesting system.

FIG. 5 is a schematic diagram illustrating an example microchannel heat exchanging contactor of a latent energy and water harvesting system with stepped inlet and outlet manifolds.

FIG. 6 is a schematic diagram illustrating an example microchannel heat exchanging contactor of a latent energy and water harvesting system with progressive inlet and outlet manifolds.

FIG. 7 is a schematic diagram illustrating a sequence of microchannel heat exchanging contactors in an air stream with cooling ports connected in parallel by stepped inlet and outlet manifolds in a latent energy and water harvesting system.

FIG. 8 is a schematic diagram illustrating two embodiments of chamber doors of a latent energy and water harvesting system.

FIG. 9 is a schematic diagram illustrating another embodiment of chamber doors of a latent energy and water harvesting system.

FIG. 10 is a schematic diagram illustrating an embodiment of a rotating chamber assembly of a latent energy and water harvesting system.

FIG. 11 is a flow diagram illustrating one embodiment of an example method of operation of a latent energy and water harvesting system.

FIGS. 12A-12B are schematic diagrams, in perspective view, of an embodiment of an example vacuum pump with moveable end plates for a latent energy and water harvesting system.

FIG. 13 is a schematic diagram, in cross-sectional view, of an embodiment of an example adjustable compression vacuum pump at maximum compression.

FIG. 14 is a schematic diagram, in section view, along a rotational axis of an adjustable compression vacuum pump at maximum compression.

FIG. 15 is a schematic diagram, in section view, along a rotational axis of an adjustable compression vacuum pump at reduced compression.

FIG. 16 is a schematic diagram, in cross-sectional view, of an adjustable compression vacuum pump at reduced compression.

FIG. 17 is a schematic diagram that shows in fragmentary, perspective view, an embodiment of a centrifugal vacuum pump.

FIG. 18 is a schematic diagram that shows, in fragmentary, perspective, cut-away view, the centrifugal vacuum pump of FIG. 17.

FIG. 19 is a schematic diagram of another embodiment of an example energy and water harvesting system.

FIGS. 20-21 are schematic diagrams that show an embodiment of a condenser comprised of multiple circular plates.

FIG. 22 is a schematic diagram of a latent energy and water harvesting system integrated in an air conditioning system.

FIG. 23 is a schematic diagram of a latent energy and water harvesting system integrated into a heat pump system where the latent energy and water harvesting system assists in heating and cooling the air.

FIG. 24 is a schematic diagram of a latent energy and water harvesting system integrated into a heat pump system where the latent energy and water harvesting system assists in heating water.

FIG. 25 is a flow diagram that shows an embodiment of an example method of harvesting thermal energy and water from air.

### DETAILED DESCRIPTION OF PREFERRED EMBODIMENTS

Certain embodiments of a latent energy and water harvesting system and method are disclosed that may be used to harvest energy in air conditioning systems in buildings and vehicles. In one embodiment, a latent energy and water harvesting system comprises plural (e.g., two or more) heat exchanging contactors, the heat exchanging contactors further comprising a coating of an adsorbent material. The adsorbent material is formulated to adsorb and desorb adsorbate (e.g., substance that has been or is to be adsorbed, such as certain gas molecules, such as water vapor) in an air stream. Contactor denotes a structure designed to maximize the collision of air stream molecules with the coating of adsorbent material. The adsorbent material comprises one or more types of a metal organic framework, or a porous zeolite, or a silica, or a combination of several hydrophilic compounds that are configured to adsorb and desorb the targeted gas molecule or molecules, e.g., H₂O for water harvesting. The coated heat exchanging contactors are thermally coupled via a heat transfer conduit or media that enables the transfer of thermal energy from an adsorbing heat exchanging contactor that is adsorbing an adsorbate from the air stream to a desorbing heat exchanging contactor that is desorbing an adsorbate. The heat transfer conduit or media enables the transfer of the heat of adsorption collected by the adsorbing heat exchanging contactor to the desorbing heat exchanging contactor to offset the heat removed by desorption. The heat transfer conduit further enables the transfer of the heat of desorption from the desorbing heat exchanging contactor to cool the adsorbing heat exchanging contactor. The exchange of thermal energy between the adsorbing and desorbing contactors enhances adsorption and desorption while canceling the heat gain that would otherwise be transferred to the air stream during adsorption. The exchange of thermal energy also allows desorption (also called regeneration) of the absorbate from the adsorbent material without requiring additional heat. The latent energy and water harvesting system further comprises two or more chambers that contain the adsorbent coated heat exchanging contactors, the chambers each configured to be alternately sealed and opened relative to each other (e.g., while one chamber is opened, the other chamber is sealed). For instance, one chamber (e.g., a first chamber) may be sealed at one instance so that the enclosed desorbing heat exchanging contactor can be placed in a partial vacuum to desorb an adsorbate from the adsorbent coating of the heat exchanging contactor, and then opened to the flow of the air stream to adsorb the adsorbate from the air stream into and onto the absorbent coating of the adsorbing heat exchanging contactor. The other chamber (e.g., a second chamber) operates the same, except sealing occurs at approximately the same period of time that the first chamber is opened, and opening of the second chamber occurs at approximately the same period of time that the first chamber is sealed.

The latent energy and water harvesting system is configured to capture the latent energy of the adsorbed gas molecules for use as heat for beneficial use, unlike conventional systems that essentially treat the thermal energy in water vapor as more of a nuisance that consumes much of its electrical power to condition air. For instance, the adsorbate may be moved to a condenser at a partial vacuum (e.g., approximately in a range from 20 millibar (mbar) to 60 mbar, though other values or range of values are contemplated to be within the scope of the disclosure). Important to the harvesting of energy and water is the use of a variable compression vacuum pump that may be operated under variable speed. The variable speed of the vacuum pump facilitates matching of rates of adsorption and desorption to keep the two chambers isothermal and to ensure the desorption cycle is completed by the time the adsorption cycle has completed. Variable compression enables proper condensing to facilitate harvesting of the thermal energy and water in various climates and at a desired temperature of the condensate. Also important to the harvesting of energy and water is the use of a variable speed pump, which is included in a thermal transfer conduit coupled to the chambers to manage the rate of thermal energy transfer as another or additional means to keep the two chambers nearly isothermal. The condensate is collected in a sump and moved to an environment of ambient pressure by a pump. The condenser is configured to collect the liquid water and heat of condensation for beneficial use, including hydronic space heating, domestic hot water heating, heating cabin air in a vehicle, or warming of an EV battery. These examples are illustrative of a few among many numbers of possible beneficial uses of the recovered heat.

In one embodiment, a latent energy and water harvesting system may be comprised of an adsorbent or adsorbents that adsorb water vapor. A number of metal organic framework (MOF) materials are engineered for adsorption of water vapor, and many do so almost exclusive of any typical gas molecule in air (e.g., many MOF materials have pore sizes engineered to fit a molecule of a certain size and/or shape, such as MIL 100(Fe), which has pores that are ideal for absorption of water molecules), which results in a condensate pumped from the condenser that is pure, or almost pure, water (e.g., distilled or non-ionic water). This pure or substantially pure water is derived from the air, from the latent energy and water harvesting system, at a very low consumption of electrical power. The water may be used for drinking water, evaporative cooling, chemical processes, hydrolysis to make hydrogen gas, among many other processes that can benefit from a clean water source.

The amount of latent energy that may be harvested is dependent upon the water content in the air, which varies with temperature and geographical location. In humid climates, the latent energy and water harvesting system may replace conventional air conditioning systems and reduce the size and electrical power consumption for heating and air conditioning in temperate zones.

Certain embodiments of a latent energy and water harvesting system address one or more drawbacks to conventional systems. For instance, some conventional dehumidification systems include beds of desiccant granules, liquid desiccants, or rotating desiccant wheels. In these types of systems, water vapor that is adsorbed or absorbed from incoming air generates heat, the heat of adsorption, and this heat elevates the temperature of the incoming air, resulting in the need for additional cooling power. Such dehumidification systems suffer from another drawback in that they are regenerated (e.g., water vapor removed) by adding more thermal energy, usually via an electric heating element, or combustion, or waste heat from another process, to drive off the water to begin adsorbing again. In contrast, the latent energy and water harvesting system herein transfers the heat of adsorption to assist regeneration, or desorption, of water vapor so that incoming air remains close to ambient temperature. In further contrast to such conventional dehumidification systems, the latent energy and water harvesting system herein uses a partial vacuum in the desorbing process, thus eliminating the need for additional thermal energy to regenerate the desiccant.

Another drawback of some dehumidification systems is that the latent heat contained in the water vapor is treated as a by-product, and hence usually returned to the surrounding environment. In contrast, the latent energy and water harvesting system herein harvests this energy, which may be used beneficially to assist in heating domestic hot water, or heating homes and business buildings or vehicles.

Another drawback of some dehumidification systems is that the captured water is also treated as a by-product and returned to the surrounding environment. In contrast, the latent energy and water harvesting system uses the harvested water for evaporatively cooling evaporators and condensers, or cooling the air in a direct or indirect evaporative cooling unit. Other uses for the harvested water include drinking water, pure water for industrial processes, and using the pure water to make hydrogen gas.

Having summarized certain features and benefits of the latent energy and water harvesting system of the present disclosure, reference will now be made in detail to the description of the latent energy and water harvesting system as illustrated in the drawings. While the latent energy and water harvesting system will be described in connection with these drawings, there is no intent to limit it to the embodiment or embodiments disclosed herein. For instance, though emphasis is placed on air conditioning systems for buildings, certain embodiments of the latent energy and water harvesting system may be beneficially deployed in vehicles as integrated into the vehicle air conditioning system, and especially, electric vehicle applications. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

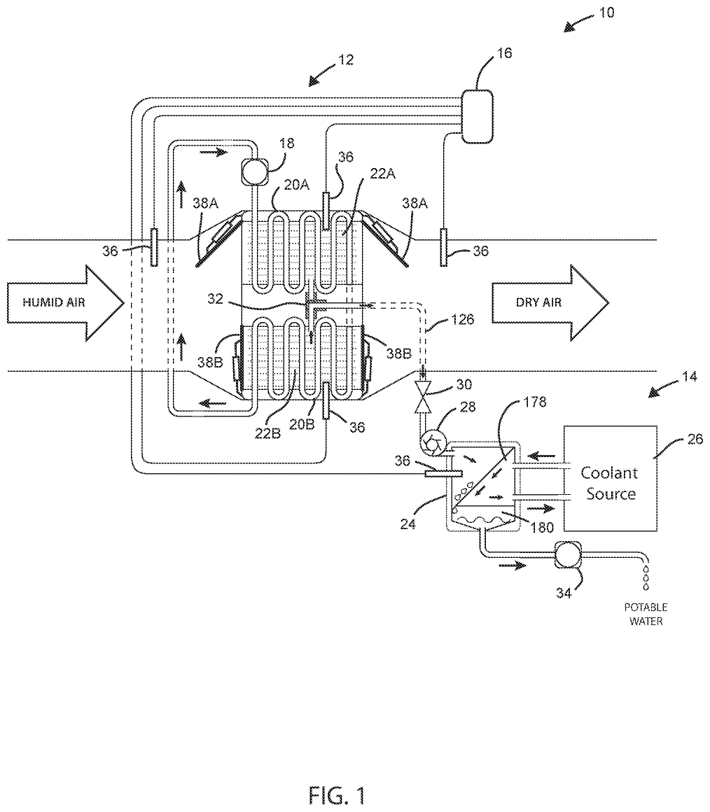

In one embodiment, shown in FIG. 1, the latent energy and water harvesting system 10 is shown, the latent energy and water harvesting system 10 comprising a heat exchange subsystem 12, an energy and water recovery subsystem 14, and a control system 16 (e.g., a controller). The heat exchange subsystem 12 comprises a loop that includes a transfer pump 18, one or more heat exchanging contactors 20 (e.g., 20A, 20B), and plural (e.g., two shown, though additional quantities may be used in some embodiments) chambers 22 (e.g., 22A, 22B) that contain the heat exchanging contactors 20. As previously described, a contactor is a structure specifically designed to maximize contact between the moving air stream and the surface of the structure, which in the current embodiment, is coated with an adsorbent material. In one embodiment, the transfer pump 18 is a variable speed pump. Note that for purposes of facilitating an understanding of the latent energy and water harvesting system 10, chamber 22A is referred to as an adsorbing chamber, whereas chamber 22B is referred to as a desorbing chamber, with the understanding that each chamber serves an adsorbing and desorbing function, and that the description that follows is intended to convey operations at a certain stage or instance or period of time. The routing of the heat of adsorption to a sealed, partial-vacuum chamber obviates the conventional need to introduce a significant amount of heat for regeneration (e.g., to release the water vapor).

The energy and water recovery subsystem 14 comprises a condenser 24 coupled to a coolant source 26, a variable compression, variable speed vacuum pump 28 arranged at an input to the condenser 24, a check valve 30 arranged at an input to the vacuum pump 28, and a valve (e.g., 3-way valve) 32 arranged between the chambers 22 and fluidly coupled to the check valve 30. In some embodiments, the condenser 24 is designed to create its own partial pressure vacuum, thereby reducing energy consumption even further. The energy and water recovery subsystem 14 further comprises a water pump 34 arranged at the output of the condenser 24. The energy and water recovery subsystem 14 captures the beneficial heat energy from the output (e.g., from the phase transition from water vapor to liquid, which is the heat of condensation), which reduces the electrical consumption that, in a conventional refrigerant vapor compression air conditioning system, would normally be consumed by the compressor (e.g., which in conventional compressor-based systems may be 90% of the total power consumed by a refrigerant vapor compressor-based air conditioning system).

The control system or controller 16 (hereinafter, referred to as a controller) receives input from plural coupled sensors 36 distributed throughout the latent energy and water harvesting system 10, including at the chambers 22, exposed to the humid air and dry air flows, respectively, and at the condenser 24 as depicted in FIG. 1. The communications between the sensors 36 may be unidirectional or bi-directional, and achieved wirelessly and/or via wired connections. In one embodiment, the sensors 36 are configured as temperature and/or humidity sensors. Other types of sensors may also be used in the same and/or additional or other locations throughout the latent energy and water harvesting system 10. The control system 16 may also provide for outputs that use control signals to trigger or actuate motive devices used throughout the latent energy and water harvesting system 10, including providing control signals for opening and closing gates or doors 38 (hereinafter, referred to as doors for brevity) of the chambers 22.

It should be appreciated that the latent energy and water harvesting system 10 depicted in FIG. 1 is one example embodiment and that some embodiments may include fewer components, additional components, or a different arrangement of components and/or different types of devices for achieving a similar function or purpose.

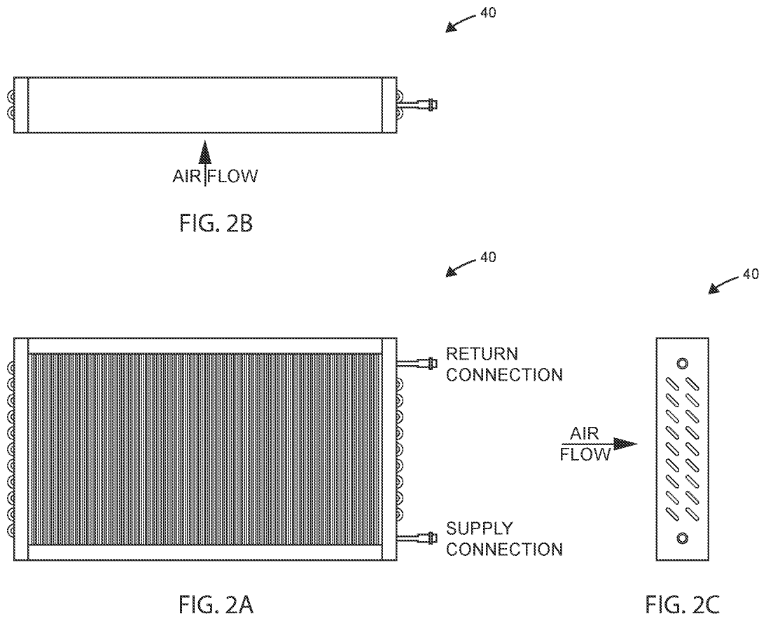

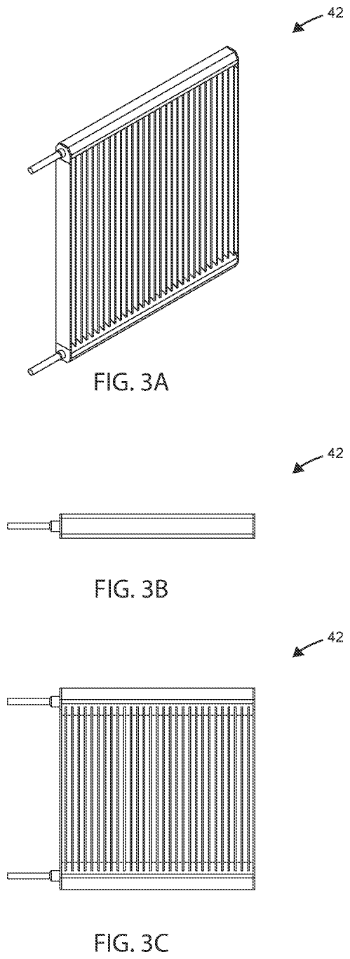

Continuing with a further explanation of the components and operations, an embodiment of the latent energy and water harvesting system 10 comprises plural (e.g., two) heat exchanging contactors 20, each of the heat exchanging contactors 20 further comprising a coating of an adsorbent material. The adsorbent material is formulated to adsorb and desorb certain gas molecules in an air stream. In one embodiment, the targeted gas for adsorption/desorption is water vapor. The adsorbent material is comprised of a metal organic framework (MOF), including MIL 100 Fe, which is engineered to adsorb water vapor from an air stream (e.g., humid air) in normal atmospheric conditions. The MOF also desorbs the water vapor when in a partial vacuum. The coated heat exchanging contactors 20 are comprised of a plurality of metal surfaces, including aluminum, copper, or other thermally conductive material. Non-metal materials, including thermally conductive composites of graphene or metallized plastics, may alternatively comprise all or part of the heat exchanging contactors 20 in some embodiments. The type of construction for each of the heat exchanging contactors 20 may be a tube and fin configuration 40, as shown in fragmentary front elevation view (FIG. 2A), overhead plan view (FIG. 2B), and side elevation view (FIG. 2C). Another type of construction for each of the heat exchanging contactors 20 may be a microchannel configuration 42 as shown in perspective view (FIG. 3A), overhead plan view (FIG. 3B), and front elevation view (FIG. 3C). Microchannel configurations have the benefits, over tube and fin types, of greater surface areas, numerous fin geometries, better thermal transfer, and worldwide manufacturers. Other possible configurations that may be used for the heat exchanging contactors 20 include rolled fin, or another structure with suitable surface area. Since tube and fin 40 and rolled fin configurations are generally known in the industry, further description of the same is omitted for brevity.

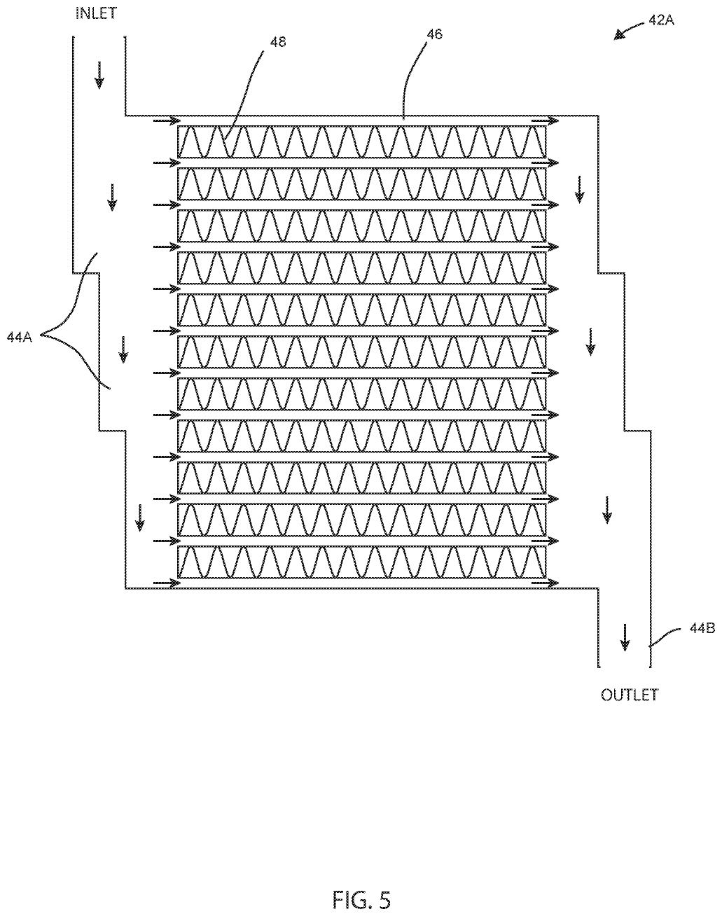

The heat exchanging contactors 20 have paths or channels for a cooling media. For instance, and referring to FIG. 5, shown is an example microchannel heat exchanging contactor configuration 42A with a stepped manifold 44 (e.g., inlet manifold 44A, outlet manifold 44B) to deliver a balanced flow of coolant to each of the microchannels 46 of the heat exchanging contactor 20. The microchannels 46 are contacted by fins 48 that contact the air stream. The fins 48 may be straight, wavy, serpentine, or louvered, and are coated with an adsorbent material as described above. The coated fins 48 transfer the heat of adsorption to the coolant flowing in the microchannels 46. The volume of each step in the manifold 44A is equivalent to the volume of the microchannels 46 branching off the step plus the volume of all of the microchannels 46 branching off subsequent steps. The steps of the outlet manifold 44B increase in volume in opposite manner. Note that reference to steps refers to the discrete, incremental change in capacity of flow volume resulting from the incremental, discrete changes in structure of the manifold.

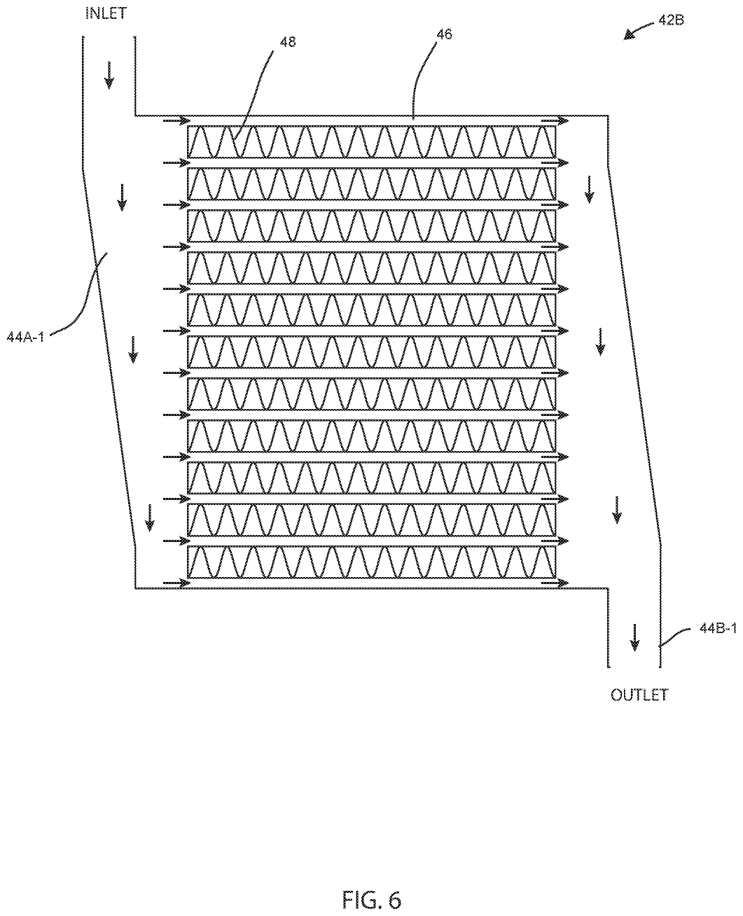

FIG. 6 shows another microchannel heat exchanging contactor configuration 42B with manifolds 44A-1 and 44B-1 comprising a continuously variable or progressive volume change. Similar to the configuration 42A of FIG. 5, the microchannel heat exchanging contactor configuration 42B comprises plural microchannels 46 and fins 48 of similar arrangement. However, in the microchannel heat exchanging contactor configuration 42B of FIG. 6, the volume of the inlet manifold 44A-1 may be decreased at a constant rate or angle (e.g., continuously variable volume) as the number of microchannel branches decreases (and increased in continuously variable manner in opposite fashion for the outlet manifold 44B-1).

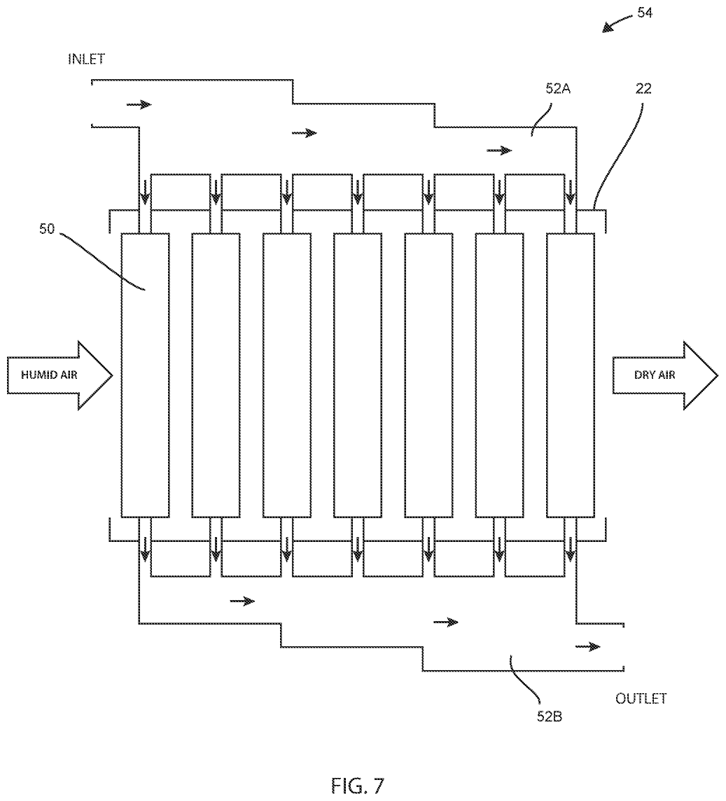

In some embodiments, plural microchannel heat exchanging contactors 50 may each be configured with stepped manifolds as similarly shown for the microchannel, fin, and manifolds shown in configuration 42A, yet connected by a master inlet stepped manifold 52A and a master output stepped manifold 52B as shown in system configuration 54 of FIG. 7. The microchannel heat exchanging contactors 50, which may comprise an embodiment of the exchangers 20 depicted in FIG. 1, are arranged sequentially in an air stream (e.g., humid air) with the coolant path through the microchannel heat exchanging contactors connected in parallel. The system configuration 54 of FIG. 7 shows seven microchannel heat exchanging contactors 50 connected in parallel to a stepped input or inlet manifold 52A on one end and to a stepped output or outlet manifold 52B at the other end, though other quantities of heat exchanging contactors 50 (e.g., two, three, four, five, six, eight, etc.) may be used in some embodiments. The number of heat exchanging contactors 50 arranged in an air stream is dependent upon volume of air, pressure drop allowed, humidity range, coolant flow, and specified dimensions of the system. Note that in some embodiments, though the master inlets and outlets 52 are depicted as stepped configurations, the master inlets and outlets 52 may be configured as continuously variable. In some embodiments, any combination of the configurations described above may be used.

The cooling media comprises a fluid, including water, water/glycol, nanofluid, or refrigerant, which flows from an adsorbing heat exchanging contactor that is adsorbing the water vapor from the air stream to a desorbing heat exchanging contactor that is desorbing water vapor. In one embodiment, and referring again to FIG. 1, the fluid may be moved in a loop (e.g., conduit, including piping, tubing, hose, etc.) by the transfer pump 18. The fluid transfers the heat of adsorption collected by the adsorbing heat exchanging contactor (e.g., 20A) to the desorbing heat exchanging contactor (e.g., 20B). The latent energy and water harvesting system 10 further comprises the plural (e.g., two) chambers 22 that each contain one of the coated heat exchanging contactors 20. The heat exchanging contactors 20 may be comprised of multiple heat exchanging contactors arranged sequentially in the air stream (e.g., as shown in FIG. 7) and the cooling paths or channels may be connected in series or parallel or a combination of series and parallel connections. The multiple heat exchanging contactors 20 may all be coated with the same adsorbent or one or more may be coated with a different adsorbent. The chambers 22 are configured so that the desorbing heat exchanging contactor (e.g., 20B) may be sealed and placed in a partial vacuum to desorb the water vapor from the MOF coating of the heat exchanging contactor 20B (a sealed or sealable state of the chamber), and after it has fully surrendered the water vapor, opened (via a pair of doors 38B that open) to the flow of the air stream to adsorb the water vapor from the air stream (a non-sealed or non-sealable state of the chamber) while the other chamber 22A is sealed in a partial vacuum and the water vapor desorbed. The sealing is achieved at least in part by the closing of the pair of doors 38 (e.g., 38A for chamber 22A, 38B for chamber 22B), each of the pair of doors 38 moved by a motive device (e.g., motor or an actuator) to a first position where it contacts a pliable material (e.g., compressible seal) such as a soft rubber ring or tube that is compressed between the door and the mouth (opening) of each end of a given chamber 22. The compression of the ring or tube is by the negative pressure of the vacuum, by force of a motive device, or both. The motive device may comprise a gear motor, a solenoid, or a pneumatic or hydraulic or electric cylinder. The movement of the doors 38 and the timing of the vacuum is controlled by the controller 16 in one embodiment. Note that a pair of doors 38 is described for each chamber, though in some embodiments, a different quantity of doors may be used for the assembly of chambers and/or for each chamber.

FIG. 1 shows each door 38A of the pair of doors 38A moves independently by actuators, though in some embodiments, a linking mechanism may be used to open the doors 38A concurrently based on a single control signal to one of the actuators. Other known mechanical configurations may be used to similar effect in some embodiments. Note that the alternating of pair of door openings (e.g., between 38A and 38B) is controlled or timed by the controller 16.

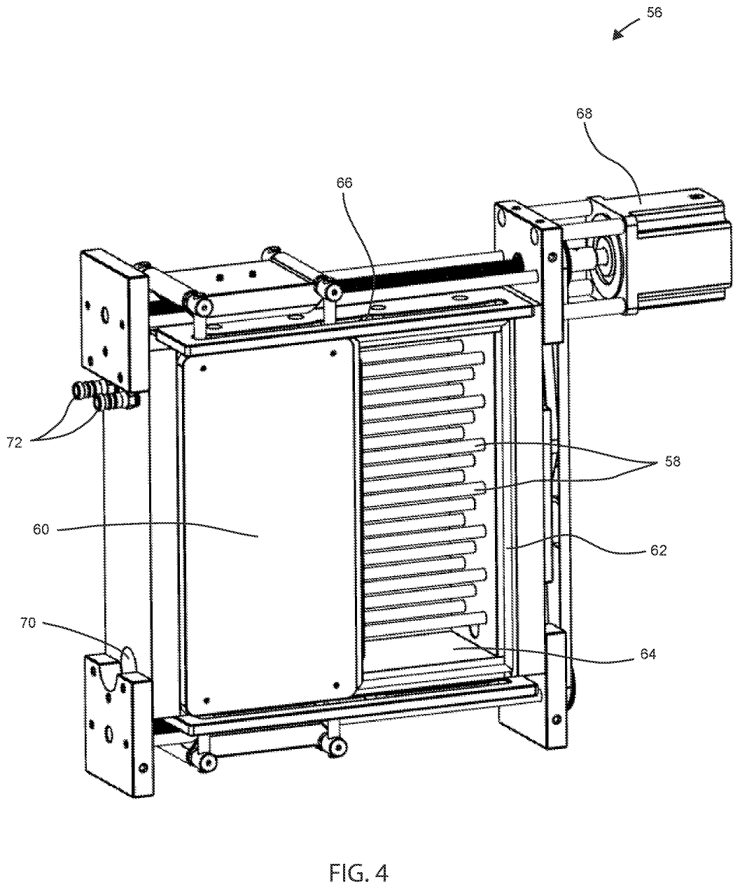

FIG. 4 shows an embodiment of heat exchanging contactor subsystem 56 where adsorbent coated heat exchanging contactors are co-located in an enclosure or housing with a pair of sliding doors to enable adsorbing and desorbing chambers. The heat exchanging contactor subsystem 56 comprises an assembly that includes a plurality of heat exchanging contactor cooling or coolant tubes 58 arranged in a volume comprising two chambers of the enclosure or housing separated by a center panel (obscured from view in FIG. 4), each chamber containing a heat exchanging contactor. For instance, one portion (e.g., half) or adsorbing chamber with coolant tubes 58 of the heat exchanging contactor is open to air flow (directionally front and back or into and out of the page in FIG. 4) to function as an adsorbing chamber while another portion (e.g., other half) or desorbing chamber on the other side of the center panel and housing another heat exchanging contactor comprising coolant or cooling tubes 58 is under partial vacuum. The partial vacuum is based on the sealing of the corresponding volume by the pair of doors 60 front and back against a corresponding tube seal 62 (obscured from view in FIG. 4 by the door 60 and other half of the door pair on the back side) that surrounds the corresponding volume opening on each side (front and back), as illustrated in the open (to air flow) volume area or adsorbing chamber 64. The doors 60 may be made of a rigid material, which may include aluminum or plastic, to withstand the partial vacuum. The tube seal 62 comprises a pliable (e.g., compressible) soft rubber tube that is arranged around the mouth of the two sides of each chamber (and attached to the center panel in the center). The door 60 is actually one door among a pair of doors (the other obscured from view and on the back side of the assembly) that slide together along a track 66 as energized by a motor 68 to seal one chamber (desorbing chamber) at one end of the track and to unseal the other chamber (adsorbing chamber) at the other end of the track. The embodiment of FIG. 4 also comprises a vacuum port 70 and cooling ports 72. The fins of the heat exchanging contactor are not shown.

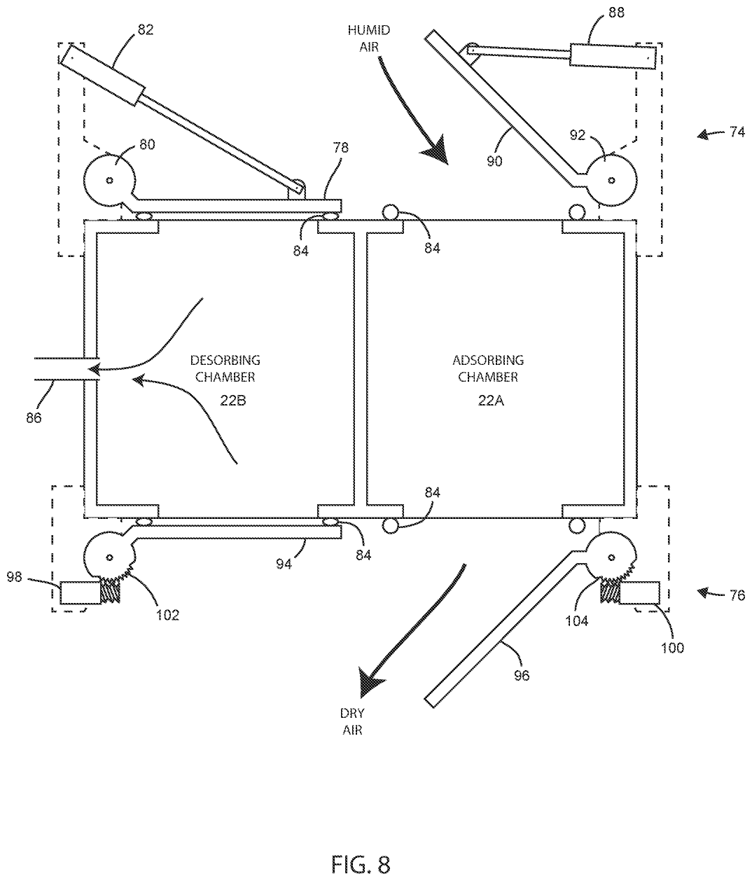

FIGS. 8-10 show various embodiments for opening and closing/sealing the chambers 22. Referring to FIG. 8, shown are two door assembly configurations 74 (upper-depicted doors of both chambers 22) and 76 (lower-depicted doors of both chambers 22) for the chambers 22 (the heat exchanging contactors not shown). The door assembly configurations 74 and 76 are shown according to functional schematic snap-shots, where one chamber at a given instance of time is referred to as a desorbing chamber 22B when sealed with a partial vacuum, and the other chamber at that instance of time is referred to as an adsorbing chamber 22A when unsealed or open to inlet air flow. In other words, it is appreciated that each chamber 22 is constructed and configured to operate as an adsorbing chamber at one instance or period of time, and as a desorbing chamber at another instance or period of time, though FIG. 8 merely shows a snap-shot at a given instance of time with the minimum construction depicted to achieve the same. Further, though a mix of door assembly types (upper-depicted configuration 74, lower-depicted configuration 76) are shown in FIG. 8, it should be appreciated that such a mix or combination of configurations is merely illustrative of the different types of door assembly configurations, and that the door assembly configurations may be the same for the inlet and outlet portion of each chamber, for all doors of all chambers, or mixed or arranged in a combination of different types in some embodiments.

Referring first to the door assembly configuration 74, as shown in the upper portion of FIG. 8 for the desorbing chamber 22B, a door 78 on a hinge 80 is closed (e.g., sealed) by the action of an actuator 82 influencing the door 78 against a tube seal 84. The tube seal 84 surrounds the mouth of a desorbing chamber 22B. The tube seal 84 is compressed by the action of the actuator 82 to seal the chamber 22B so that a vacuum (via vacuum line 86) can be present in the desorbing chamber 22B. The tube seal 84 is also compressed by the negative pressure pulling the door 78 inward. The adsorbing chamber 22A shows a second actuator 88 pulling a second door 90 relative to a hinge 92 to the open position to allow the air stream to travel over the adsorbent material of the heat exchanging contactors (not shown). Note that the description above refers to each door 78 and 90 in operation based on the respective actuator 82, 88 relative to a respective hinge 80, 92, though in actual operation, there are a pair of doors on each end of the chamber that are activated concurrently for each chamber 22 (either via a control signal to actuators for that particular chamber, or linkage mechanism whereby one actuator at one end of the chamber causes the same action on the actuator or other mechanical mechanism on the opposing end of the given chamber).

Referring to the door assembly configuration 76, the doors 94 (for the desorbing chamber outlet) and 96 (for the adsorbing chamber outlet) are shown in the lower portion of FIG. 8. In this embodiment, a respective gear motor 98, 100 meshes with gear teeth on a portion of a respective hinge 102, 104 to close or open the respective door 94, 96 on a desorbing chamber 22B or adsorbing chamber 22A. Again, in operation, the inlet/outlet doors for each chamber are actuated to either open or close at the same time, and the controller 16 is used to coordinate the opening of the pair of doors for one chamber (adsorption) while at the same or substantially the same time and time period, close the doors for the other chamber (desorption). Similar to the description above for the sealing features for the door assembly configuration 74, tube seals 84 are shown in FIG. 8 surrounding the outlet of each chamber to enable the partial vacuum to be achieved during desorption.

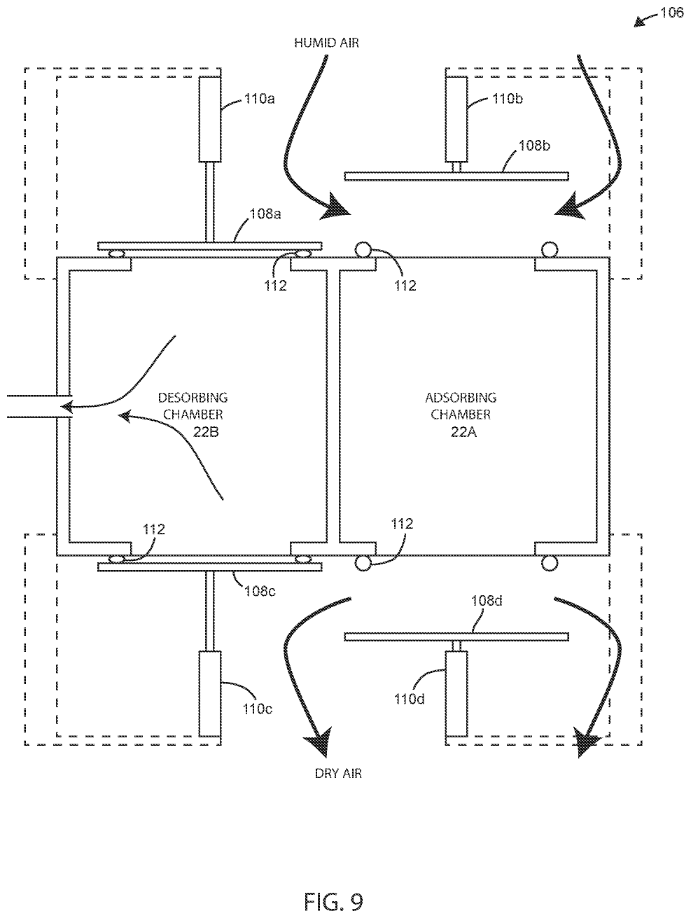

FIG. 9 shows another door assembly configuration 106 that illustrates an embodiment of a pair of doors 108 (e.g., doors 108a, 108c for desorbing chamber 22B, doors 108b, 108d for adsorbing chamber 22A) where, for instance, a respective actuator 110a, 110c moves the door 108a, 108c onto a tube seal 112 surrounding the mouths of a desorbing chamber 22B in a direction which is perpendicular to a plane of the mouths of the chamber 22B. The actuator is attached to a support, which does not restrict the air flow into the adsorbing chamber 22A when the door is in an open position (e.g., via actuation of respective actuator 110b, 110d with regard to respective door 108b, 108d).

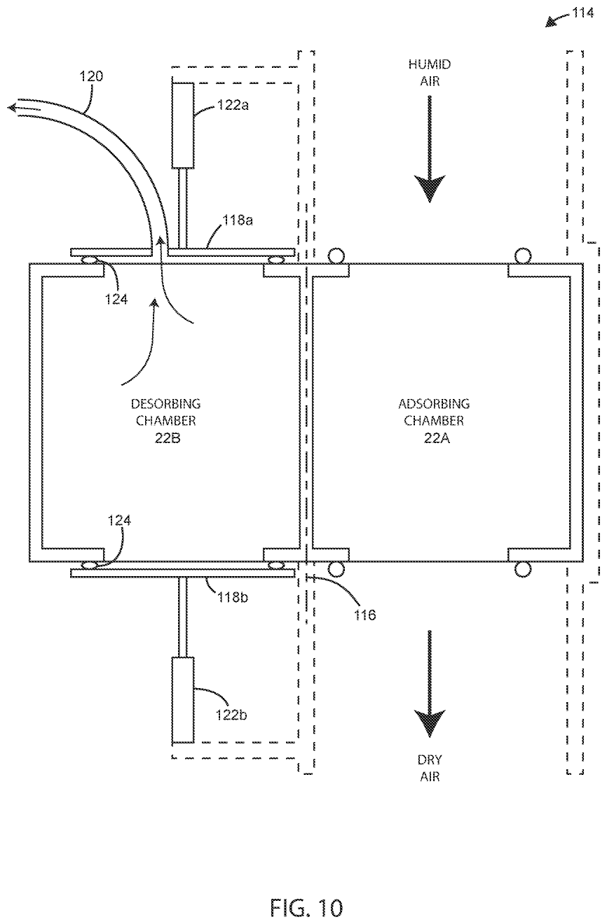

FIG. 10 shows a door assembly configuration 114 where the two chambers 22 comprise an axis of rotation 116 so that a single pair of doors 118 (e.g., 118a at inlet, 118b at outlet) may be used for the desorbing chamber 22B. A vacuum line 120 is attached to one door (e.g., 118a). A respective actuator 122 pushes a respective door 118 into contact with a tube seal 124 and then compresses the tube seal 124 with the assistance of the vacuum pressure. The adsorbing chamber 22A is open to the air stream. To switch the chambers from desorbing to adsorbing and adsorbing to desorbing, the vacuum is released, the doors are opened, and the assembly comprising the two chambers is rotated by a motor or actuator (not shown) on the axis of rotation 116 to place the chambers in opposing positions to start the next cycle (e.g., now adsorbing chamber 22A is on the left-hand side of FIG. 10, serving the function of a desorbing chamber, and the desorbing chamber 22B is rotated to the right-hand side of FIG. 10, serving the function as an adsorbing chamber).

Referring back to FIG. 1, the chambers 22 are connected by the valve 32 (e.g., three-way valve) to a vacuum line 126 leading to the vacuum pump 28. Note that vacuum line 126 may serve as vacuum line 86 (FIG. 8) or vacuum line 120 (FIG. 10). The three-way valve 32 is moved by a motive device (e.g., motor or solenoid). The three-way valve 32 switches the vacuum to the sealed desorbing chamber 22B and provides for evacuating of the water vapor from the adsorbent material. The three-way valve 32 may be directly between the chambers 22 as shown in FIG. 1, or in some embodiments, it may be two or more valves connected by conduit, which may include pipes, tubing, and/or hoses (and valves, pumps and/or other components), to ports through the wall of each chamber 22. The water vapor is drawn via conduit through the check valve 30 that keeps the desorbing chamber 22B under vacuum until the three-way valve 32 is switched over to connect to the adsorbing chamber 22A, which results in a release of the pressure on the chamber doors 38B and allows the doors 38B of the desorbing chamber 22B to open.

The vacuum pump 28 is now connected via conduit to the adsorbing chamber 22A. The chamber doors 38A of the adsorbing chamber are closed (sealed), and the vacuum pump 28 moves the air out of the chamber 22A and the water vapor begins desorbing from the adsorbent material under the partial vacuum according to the alternating function of each chamber.

As explained above, a number of sensors 36, including temperature, humidity, and pressure sensors, are placed in the two chambers 22 and in the air stream before and after the heat exchanging contactors 20, as well as before or, as shown in FIG. 1, after the vacuum pump 28. The sensors 36 are monitored by the controller 16. The controller 16 adjusts the timing of the chamber doors 38, the operation of all the pumps 18, 28, 34, and the three-way valve 32 based upon the conditions monitored by the sensors 36. For example, if the temperature of the desorbing chamber 22B falls below a programmed minimum temperature, then the controller 16 can increase the speed of the transfer pump 18 to move more heat from the adsorbing chamber 22A and slow the vacuum pump 28 to reduce the rate of desorption. Also the speed of transfer pump 18 is controlled to maintain the temperature of the adsorbing chamber 22A within a few degrees of the desorbing chamber 22B, preferably four to five degrees C. In one embodiment, the speed of either pump (e.g., the vacuum pump 28 or the transfer pump 18) may be adjusted to keep the chambers isothermal. For instance, speeding up the vacuum pump 28 increases the rate of desorption, which soaks up more heat, and speeding up the transfer pump 18 moves (transfers) more heat from the adsorbing chamber to the desorbing chamber. In some embodiments, either or both may be adjusted to keep the temperature of each chamber close together.

In one embodiment, the controller 16 may comprise a computer or computer device (e.g., an electronic control unit or ECU), a programmable logic controller (PLC), field programmable gate array (FPGA), application-specific integrated circuit (ASIC), among other devices, and in some embodiments, functionality of the latent energy and water harvesting system may be implemented using plural controllers (e.g., using a peer-to-peer or primary-secondary methodology). In one embodiment, the controller 16 comprises one or more processors, input/output (I/O) interface(s), and memory, which may all be coupled to one or more data busses. The memory may include any one or a combination of volatile memory elements (e.g., random-access memory RAM, such as DRAM, and SRAM, etc.) and nonvolatile memory elements (e.g., ROM, Flash, hard drive, EPROM, EEPROM, CDROM, etc.). The memory may store a native operating system, one or more native applications, emulation systems, or emulated applications for any of a variety of operating systems and/or emulated hardware platforms, emulated operating systems, etc. The memory may comprise a non-transitory medium that may store software for implementing functionality of the latent energy and water harvesting system as described above.

Execution of the software may be implemented by one or more processors of the controller 16 (or plural controllers) under the management and/or control of an operating system, though in some embodiments, an operating system may be omitted. Such processors may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 16.

When certain embodiments of the controller 16 are implemented at least in part as software (including firmware), it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the controller 16 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

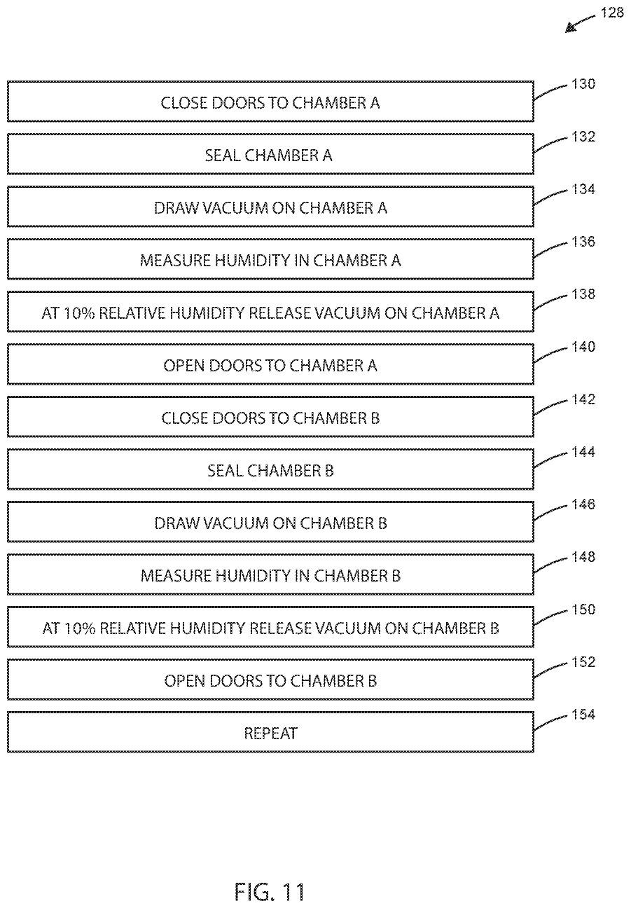

FIG. 11 illustrates an embodiment of an example method 128 of operation of the adsorbing and desorbing chambers as described above. The method 128 may be implemented using programming code that is executed by the controller 16 in conjunction with one or more motive devices and input from one or more sensors. The designation of chamber A and B is arbitrary, and is only meant to describe the sequence of adsorbing and then desorbing in one chamber while desorbing and then adsorbing in a second chamber. Temperature and humidity sensors may be placed in each chamber, and the humidity level sensed is one possible method of triggering the cycle change for the chambers. An alternate method is to use the temperature and humidity of the incoming air stream based on preset parameters that determines the amount of time for each adsorb/desorb cycle. Another method is to use the temperature in each chamber to determine the trigger points for each cycle change for the chambers. In view of the above-description associated with FIGS. 1-10, it should be appreciated by one having ordinary skill in the art that, in one embodiment, the method 128 comprises closing the doors (e.g., the pair of doors) to chamber A (130), sealing chamber A (132), drawing a vacuum on chamber A (134), measuring humidity in chamber A (136), at a predefined relative humidity (e.g., 10%, though not limited to 10%), releasing the vacuum on chamber A (138), and opening doors to chamber A (140). The method 128 further comprises closing doors (e.g., the pair of doors) to chamber B (142), sealing chamber B (144), drawing a vacuum on chamber B (146), measuring humidity in chamber B (148), at a predefined relative humidity (e.g., 10%), releasing the vacuum on chamber B (150), opening doors to chamber B (152), and repeating the method (154).

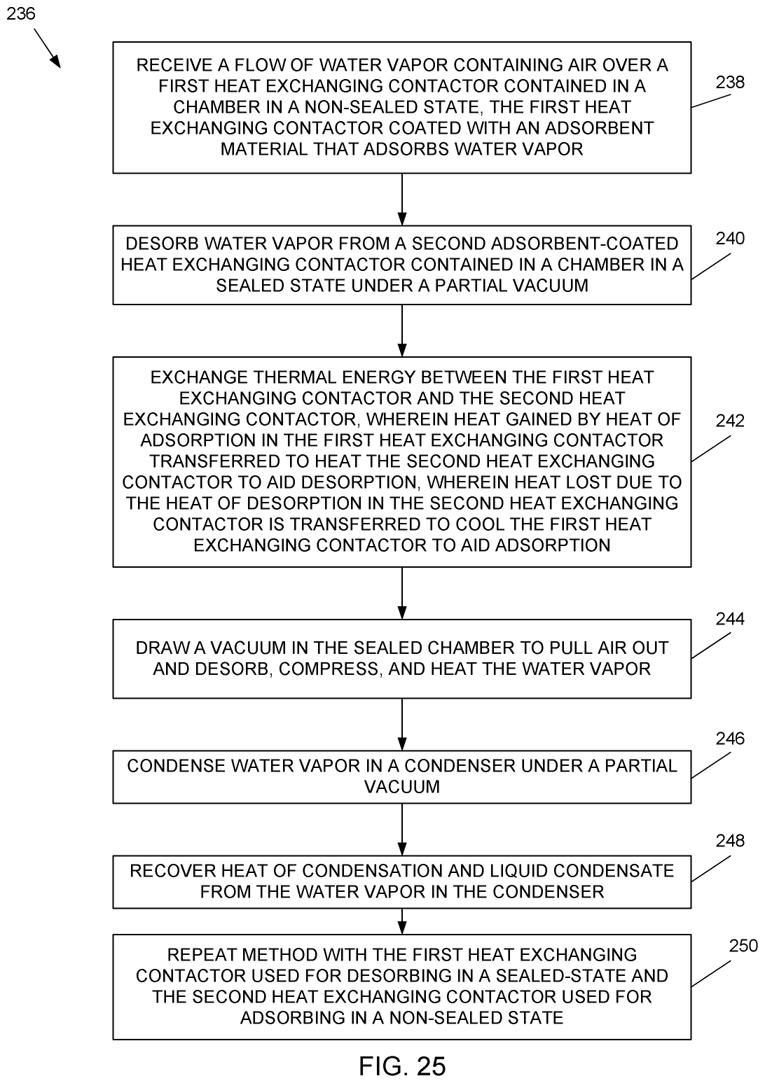

Any process descriptions or blocks in the flow diagram of FIG. 11 (and FIG. 25 below) should be understood as representing modules, segments, or portions of code, or acts/steps which may include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

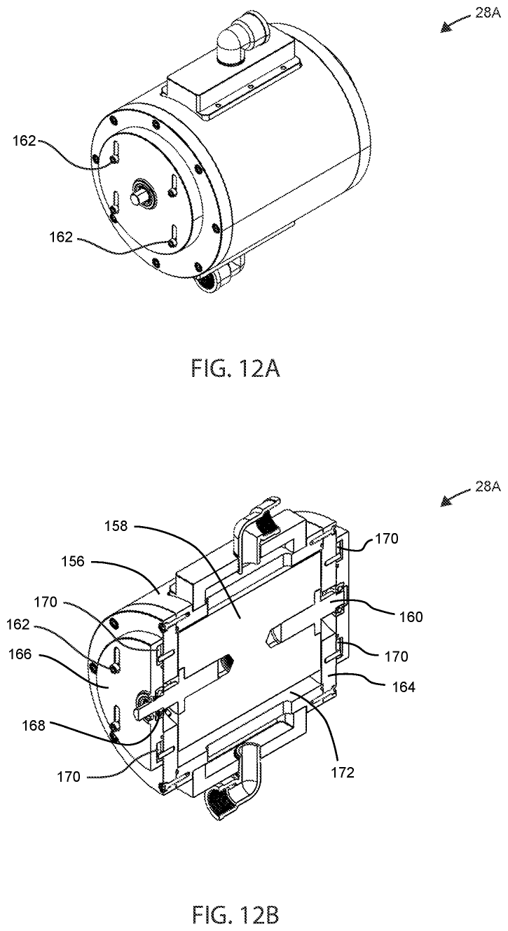

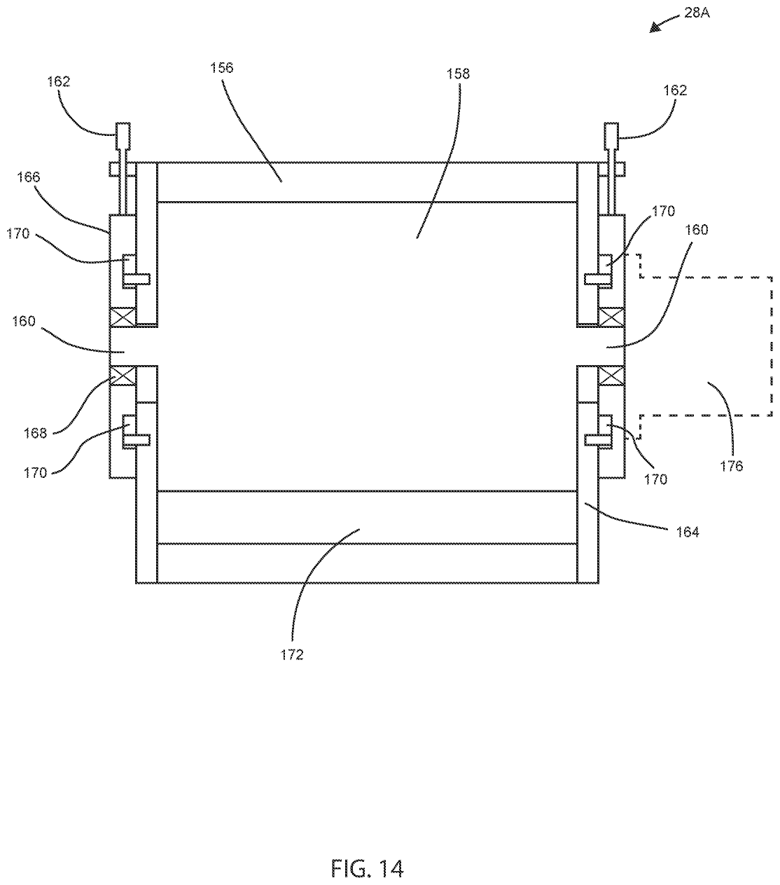

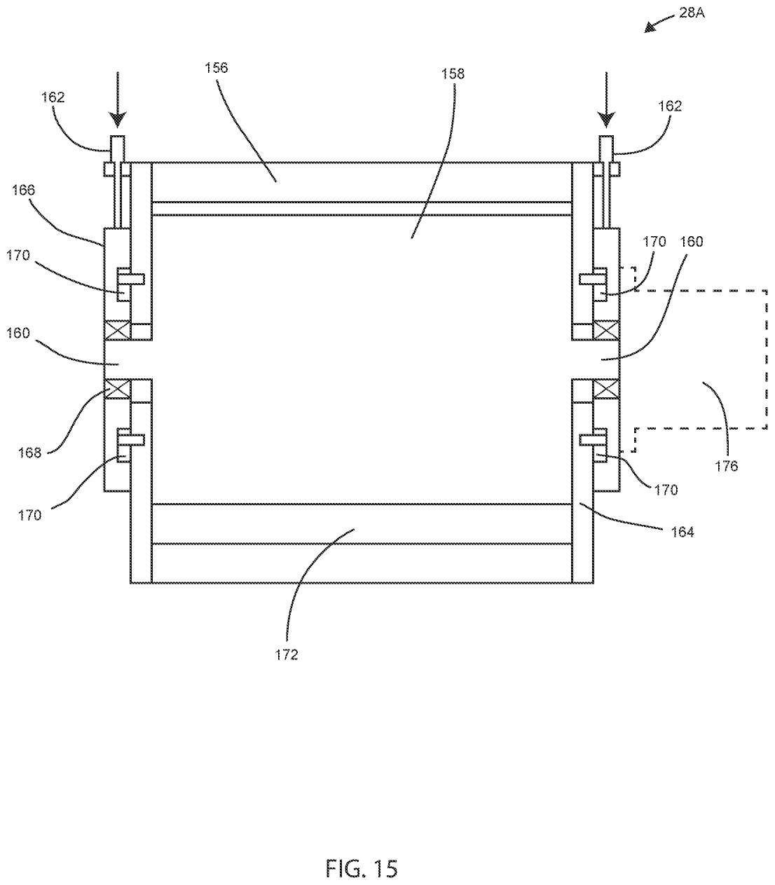

FIGS. 12A-12B show one embodiment of a vacuum pump 28A for the latent energy and water harvesting system 10, with FIG. 12A showing the vacuum pump 28A in perspective view, and FIG. 12B showing the vacuum pump 28A in perspective, cut-away view. With continued reference to FIG. 1, the vacuum pump 28A depicted in FIGS. 12A-12B is configured as a low torque, low-compression (e.g., approximately 1.6-1.8 compression ratio), high volume pump to move water vapor to the condenser 24 without the water vapor condensing within the pump 28A. The vacuum pump 28A may comprise a rotary vane pump with a variable compression ratio, however other types of pumps may be used, including centrifugal, diaphragm, or peristaltic pumps. In some embodiments, a series of two or more vacuum pumps that can be independently controlled may be implemented to function like a single variable compression pump. In FIGS. 12A-12B, the vacuum pump 28A comprises a cam ring 156, a rotor 158 with moveable blades, a rotor shaft 160, and an adjustment mechanism, which in one embodiment comprises fasteners 162, to change the compression of the pump. The adjustment mechanism, though depicted at the one end using four fasteners 162 (e.g., screws, levers, etc.) to facilitate manual adjustment, may be configured in other quantities and/or physically configured to be used with a motive device, such as a push-rod actuated by an actuator, or in some embodiments, a threaded rod actuated by a motor. Note that the adjustment mechanism is enabled at both ends (the other set of fasteners 162 not shown for the other end), though some embodiments may use only a set at one end to enable the adjustment. The vacuum pump 28A may also comprise a variable speed motor coupled thereto (best shown in FIG. 14, motor 176), which connects to one end of the rotor shaft 160. The adjustment mechanism (e.g., via manipulation of the fasteners 162, or automatically in some embodiments as described above) allows the center of rotation to be adjusted to change the swept volume between the rotor 158 and the cam ring 156 to change the compression of the pump 28A. The vacuum pump 28A further comprises a pair of end plates 164, a pair of carrier plates 166, which hold shaft bearings 168 for the rotor shaft 160, a guide slot or slots 170 in the carrier plates 166, and a number of fasteners 162 to secure the carrier plates 166 to the end plates 164. Loosening or removing the fasteners 162 allows the carrier plates 166 to be guided by the slots 170 in a direction perpendicular to the axis of rotation of the rotor. Moving the carrier plates 166 along the slots changes a swept volume 172 between the moveable blades, the cam ring 156, and the rotor 158, which enables the compression of the pump 28A to be adjusted. The adjustment mechanism shown in FIGS. 12A-12B enables the vacuum pump 28A to be set for a certain range of performance for the latent energy and water harvesting system 10. The fasteners 162 are tightened once the carrier plates 166 are in position. Note that FIGS. 14-15, described below, show example interactions of the fasteners 162 relative to the slots 170, which reside between the carrier plates 166 and the end plates 164, where the fasteners 162 hold the carrier plates 166 in position.

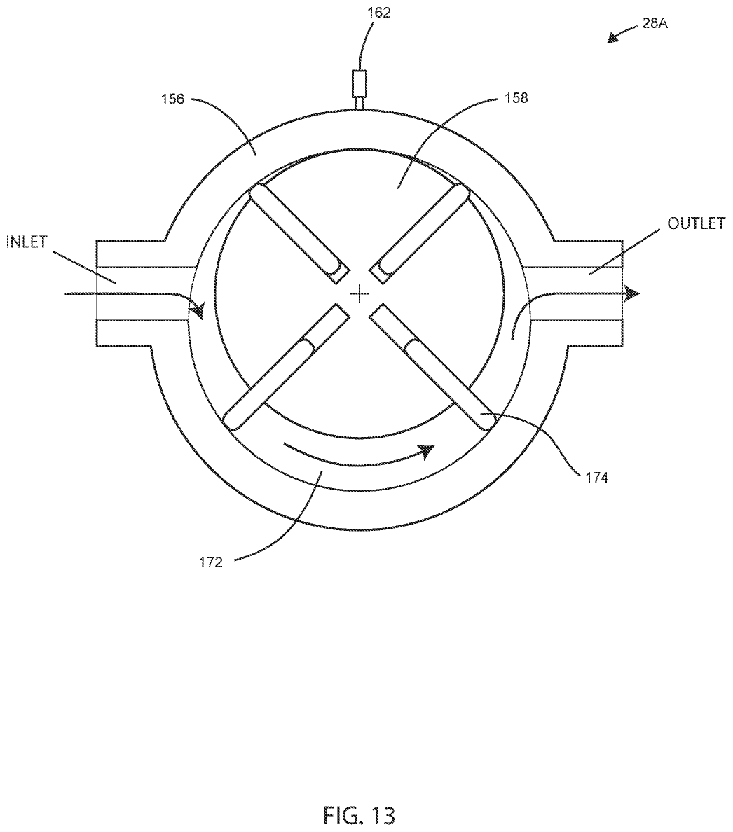

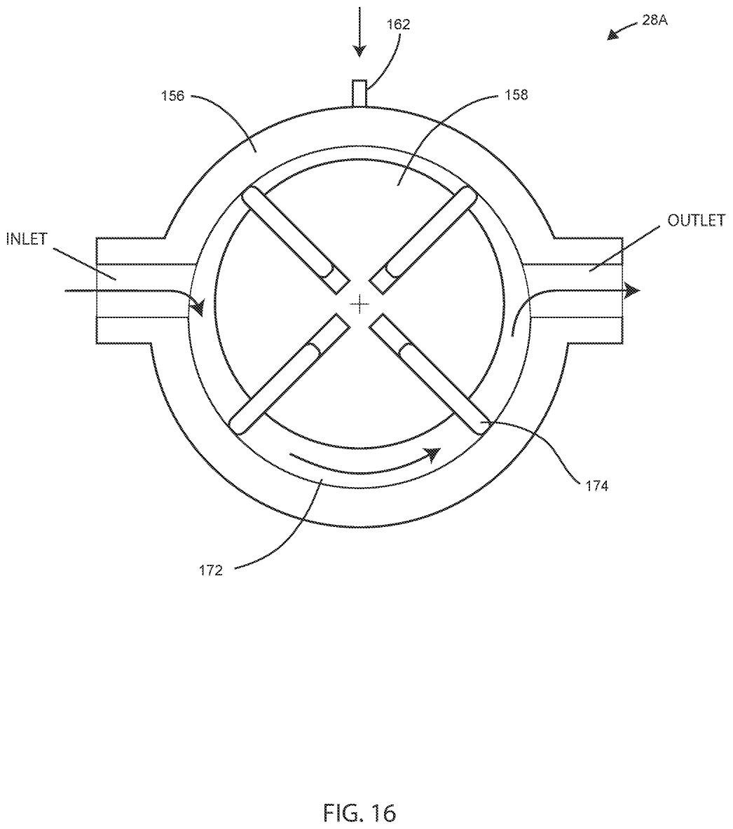

With continued reference to FIGS. 12A-12B, FIGS. 13-16 are schematic diagrams that show in fragmentary, cross-sectional and sectional views, the use of the adjustment mechanism to adjust the compression ratio of the vacuum pump 28A. As explained above, the adjustment mechanism may comprise a pair of movable members (e.g., push-rods, fasteners 162 such as screw, etc.) attached at the carrier plates 166 and actuated by a motive device (e.g., cylinders or actuators, motor, etc.). The movable members may have a support structure to help guide the member and also to support a motor or actuator at another end. The motor or actuator is coupled to the controller 16. FIG. 13 shows a cross-sectional view of the vacuum pump 28A at maximum compression, where the swept volume 172 moved by the blades 174 is at maximum volume. In this position, the center of the rotor 158 is at a maximum offset from the center of the cam ring 156. FIG. 14 shows a longitudinal section of the pump 28A at maximum compression with the rotor 158 adjusted up to the top inner surface of the cam ring 156, maximizing the swept volume 172 along the bottom inner surface of the cam ring 156. The adjustment mechanism (e.g., referred to interchangeably hereinafter as the fasteners 162, with the understanding that moving members of other forms may be used in some embodiments) on each carrier plate 166 are at maximum travel upward. In FIG. 15, the adjustment mechanism 162 is forced downward by a motive device (e.g., motor or actuator), pushing the carrier plates 166 with shaft bearings 168 downward, which moves the rotor 158 downward, decreasing the swept volume 172 and so decreasing the compression of the pump 28A. FIG. 16 shows a cross-sectional view of the vacuum pump 28A with the rotor 158 moved downward, reducing the swept volume 172, which decreases the compression of the pump 28A.

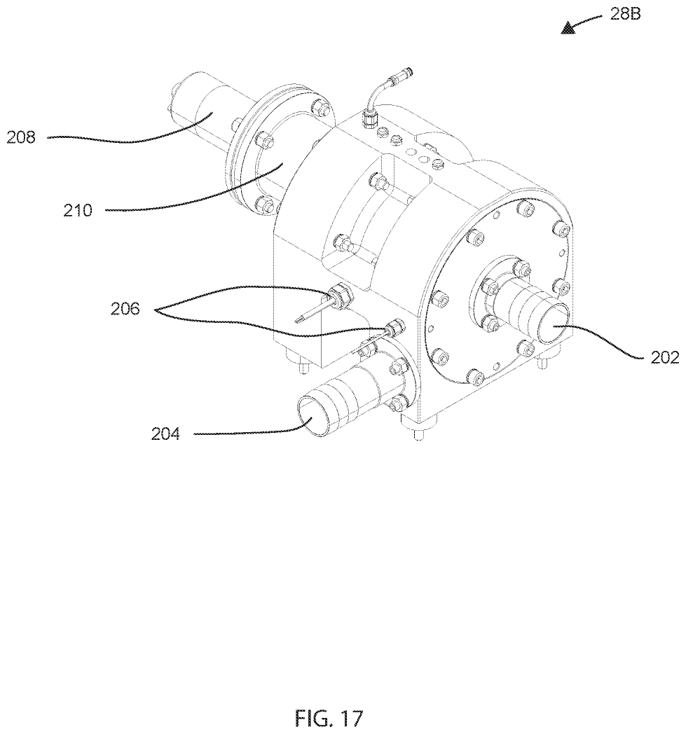

With continued reference to FIG. 1, FIG. 17 shows an embodiment of a centrifugal vacuum pump 28B of the latent energy and water harvesting system 10. Centrifugal vacuum pump 28B has an inlet 202, an outlet 204, sensor ports 206, a motor 208, and a gearbox 210. The centrifugal vacuum pump 28B uses the rotation of specially configured fan blades on a rotor to evacuate the water vapor from the desorbing chamber connected to the inlet 202. For instance, in one embodiment, the fan blades comprise dual layered volutes (inducer and exducer) with backward swept tips, such as for efficiency and noise reduction at high speeds. The outlet 204 is connected to condenser 24. The water vapor is compressed 20 to 40 millibars (e.g., in one embodiment, total compression of water vapor is 20 millibars, and in some embodiments, total compression is 40 millibars, or 60 millibars or higher in some embodiments) as it moves into condenser 24. The compression may vary depending on the desired pressure to condense based on the application. The temperature of the water vapor increases 20 to 40 degrees (Celsius) above the ambient temperature as it is compressed. The temperature of the water vapor under vacuum increases to the condensation point, which allows condenser 24 to condense water vapor in any ambient temperature. The centrifugal vacuum pump 28B has a high rotation speed (e.g., 100,000 rpm), which is needed to move enough mass of low-pressure water vapor out of the MOF and into condenser 24. The centrifugal vacuum pump 28B may be directly driven by a high-speed motor, by a gear motor, or by a turbine impeller driven by a high-volume blower. In one embodiment, the centrifugal vacuum pump 28B has a variable compression ratio from 1.4:1 up to 2:1. The compression ratio may be changed by varying the speed of the pump 28B. Changing the compression ratio changes the temperature of the water vapor entering condenser 24. This allows the latent energy and water harvesting system 10 to condense in a wide range of ambient conditions, and also allows for increasing the temperature of the harvested liquid water for better utility in applications that benefit from warm water, such as domestic hot water heating or hydronic space heating.

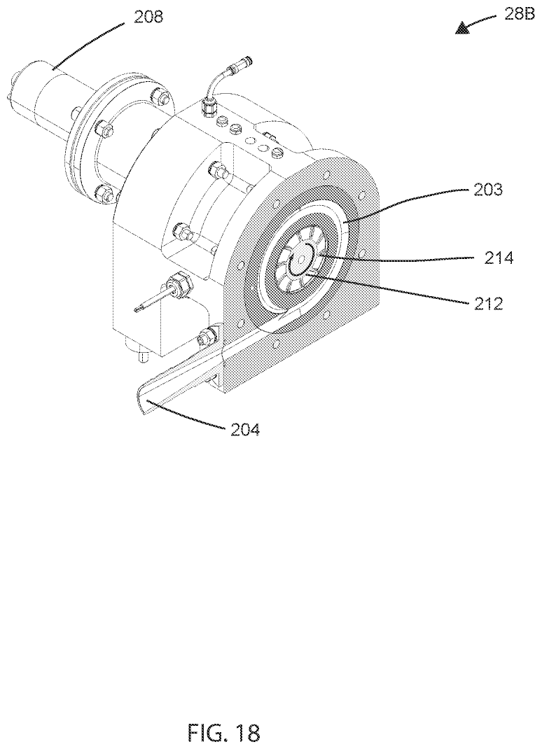

FIG. 18 shows a perspective, cut-away view of centrifugal vacuum pump 28B. A rotor 212 with fan blades 214 is turned by the high speed motor 208 to draw the water vapor into the inlet 202, shown in FIG. 17, and then outward along a vapor path 203 around through the outlet 204 which is connected to condenser 24 as shown in FIG. 1.

Referring again to FIG. 1, once the water is in a liquid state, it is relatively non-compressible, and it is pumped to ambient pressure (for storage or other use) using the pump 34 that requires only a modest amount of power. Controlling the temperature of the water vapor in the vacuum pump 28 to optimize the temperature differential between the water vapor and the condenser 24 enables the latent energy and water harvesting system 10 to maximize liquid water output and usable thermal energy in the form of warm water to use for beneficial purpose, such as hydronic heating or warming an air stream.

The condenser 24 comprises a metal surface 178 where the water vapor can condense and fall into a sump 180. The surface 178 may be comprised of one or more walls, multiple tubes, or fins to provide the necessary surface area for condensation and heat transfer. The surface 178 may be angular, cylindrical, or cone shaped. The surface 178 transfers the heat of condensation to a cooling media, such as water or water/glycol, which flows in a cavity, tubes, or channels near the surface 178. The cooling media is warmed and flows away from the condenser 24 where the heat may be used in other processes. The liquid water collects in the sump 180 and may be moved by the water pump 34 to a storage tank (not shown) where it can be used for other processes or consumption. The condenser 24 is useful in capturing the latent heat energy from the water vapor and is preferably insulated from the environment to maximize the capture of the useful thermal energy. The insulation may be a foam or fiberglass layer wrapped around the condenser 24, or the condenser may be enclosed in a rigid housing and the space in between the housing and the condenser is under vacuum.

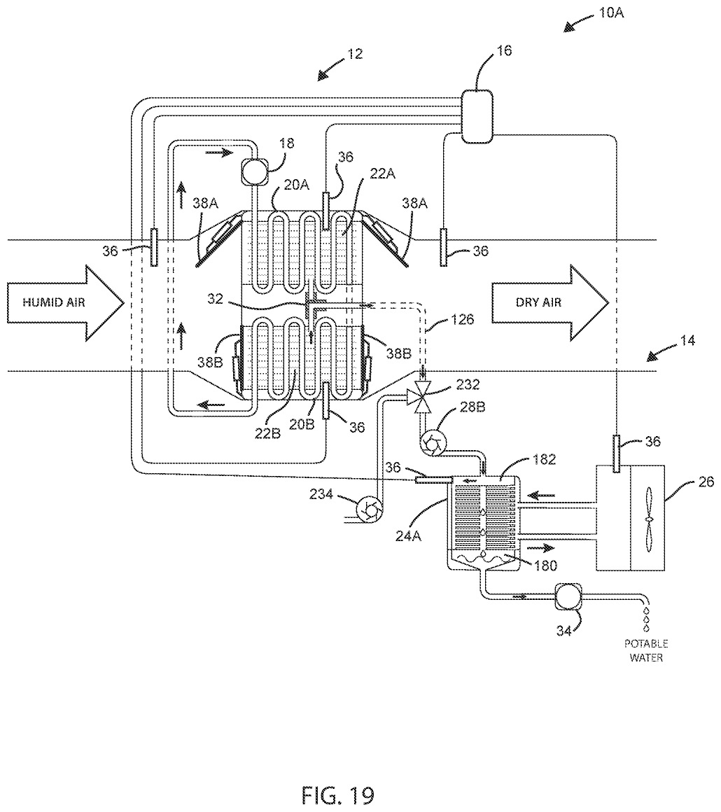

FIG. 19 shows an embodiment of a latent energy and water harvesting system 10A, which has similar features (similar features having the same reference number) to the latent energy and water harvesting system 10 of FIG. 1 with some notable differences. For instance, FIG. 19 shows an embodiment of condenser 24A which receives low pressure water vapor from the vacuum pump 28B. The density of the water vapor increases by more than 20,000 times as it condenses to liquid water. This is ten (10) times the increase than if it were condensing at ambient pressure. Radiators or shell and tube condensers are less efficient at condensing partial pressure water vapor. Plate heat exchangers are better at compressing low density water vapor since it is possible to customize the plate layers.

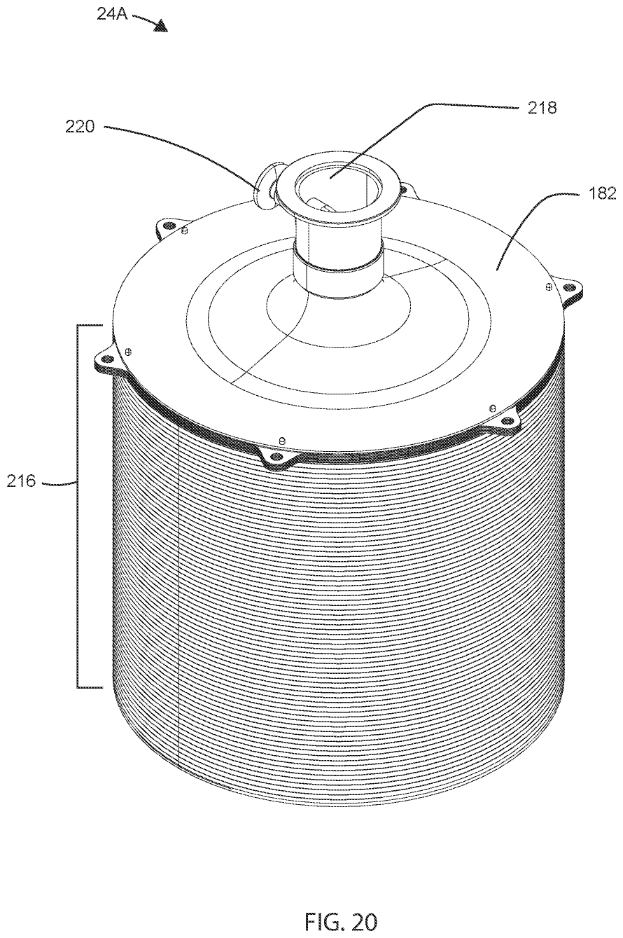

FIG. 20 shows condenser 24A which is comprised of multiple circular plates 216, a vapor inlet 218, a cooling port 220, and a vapor manifold 182. The circular plates 216 are configured to allow flow of either water vapor or cooling fluid.

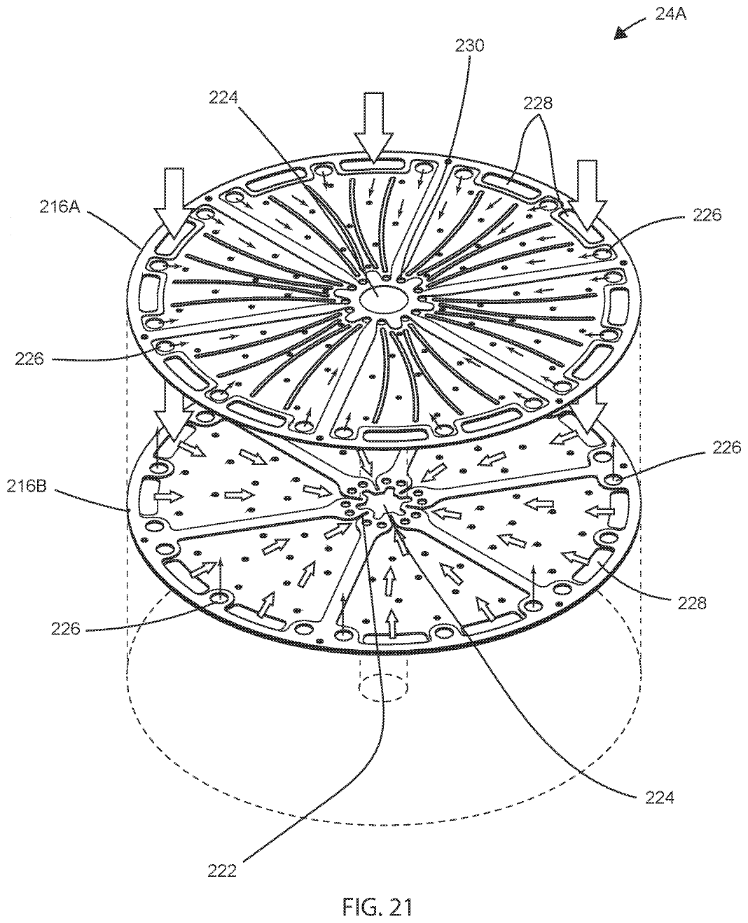

FIG. 21 shows representative plates 216 (e.g., 216A, 216B) which comprise circular condenser 24A. The plates 216 are made of a thermally conductive material such as aluminum or stainless steel, and are stamped, laser cut, or etched. The circular plates 216 are then stacked and brazed, soldered, or welded. Openings in each plate form pathways up and down the stack of circular plates 216 for movement of water vapor and cooling fluid. A vapor plate 216 B permits the flow of water vapor from large openings 228 at the outer circumference toward small condensate ports 222 at the inner circumference where the condensed liquid water exits. The large openings 228 are contiguous with vapor manifold 182 shown in FIG. 20. The condensate ports 222 are contiguous with a central condensate channel 224 in the center of the plates 216. The central condensate channel 224 allows the condensed liquid water to flow into a sump 180. A cooling plate 216A permits the flow of cooling fluid from the outer cooling ports 226 at the outer circumference of the plate towards the inner cooling ports 230 near the inner circumference. The outer cooling ports 226 are contiguous with the cooling port shown in FIG. 20. The inner cooling ports 230 are contiguous with a cooling port (not shown) at the bottom surface of condenser 24A.

Referring back to FIG. 19, coolant source 26, which in one embodiment is a liquid to air heat exchanger as shown in FIG. 19, uses ambient air to reject the heat in the fluid coming from condenser 24A. This keeps the fluid flowing back to condenser 24A close to ambient temperature. Another difference from system 10 (FIG. 1) is in the addition of a temperature/humidity sensor 36 at the coolant source 26. As similarly described for system 10 of FIG. 1, temperature and humidity sensors 36 likewise in system 10A provide measurements to the controller 16 to provide feedback for the vacuum pump compression and motor speed, and may also use additional sensor data from the coolant source 26 to the condenser 24A to help maintain the temperature of the cooling fluid by controlling a fan that blows the air over the heat exchanger (coolant source 26) so that condenser 24A is able to condense water in a wide range of ambient temperatures as well as the output temperature of the liquid water. A three-way valve 232 provides a connection to a secondary vacuum pump or purge pump 234 that allows non-condensable gases to be removed at the beginning of each desorption cycle. The vacuum pump 28B may be specifically configured to move water vapor at a low compression ratio, such as 1.6:1, and therefore cannot efficiently draw out the air from the desorption chamber without choking or surging. The purge pump 234 may be any of a number of widely available pumps such as a diaphragm pump or a radial vane pump. The purge pump 234 may alternatively be located after condenser 24A near water pump 34, or may be a dual function pump that purges the air from the desorption chamber and also removes the condensate from sump 180. The water pump 34 that controls the output of the liquid water may be variable speed to keep the water level in the bottom of the condenser 24A from overflowing or running dry. A water level sensor may be incorporated into sump 180.

In general, certain embodiments of a latent energy and water harvesting system recover the latent energy of a gas, such as water vapor, in the atmosphere, and collect the condensate for reuse or storage. The adsorbent coating on the heat exchanging contactors may alternatively comprise an adsorbent such as a MOF configured to adsorb carbon dioxide, sulfur dioxide, or other gases for reuse or removal from the atmosphere. However, water vapor is a larger fraction of the air flow than carbon, sulfur, or nitrogen oxides, and so is a much larger reservoir of latent energy in the atmosphere. An adsorbent comprising a MOF that is extremely hydrophilic in ambient conditions and then easily releases the water vapor in a partial vacuum is generally preferred to maximize the harvesting of latent energy in the atmosphere. Some examples of MOF include MIL-100(Fe), MOF 303, and MOF 801.

As explained above, in some types of systems, a saturated adsorbent is desorbed (regenerated) by application of heat. The heat source is often an electric coil, which uses a significant amount of electrical energy since the coil must offset the heat taken by the water vapor leaving the adsorbent. For instance, the thermal energy released during adsorption is 630 to 690 watt hours per liter of water, depending upon temperature, properties of adsorbent, and relative humidity. An electric coil uses 630 watts of electric energy to desorb 1 liter of water, which results in a coefficient of performance (COP) of 1. In contrast, certain embodiments of a latent energy and water harvesting system use a vacuum to regenerate the adsorbent material, which uses approximately 40 watt hours per liter, providing a COP of 16 to desorb the water vapor. Variations in efficiency in vacuuming the water vapor and condensing the water for different applications may result in a COP range from 10 to 20. For example, an embodiment of the latent energy and water harvesting system that is able to condense the water vapor at a temperature below ambient is able to achieve a COP of 20 because the power consumed by the vacuum pump is lowered to 30 watt hours per liter.

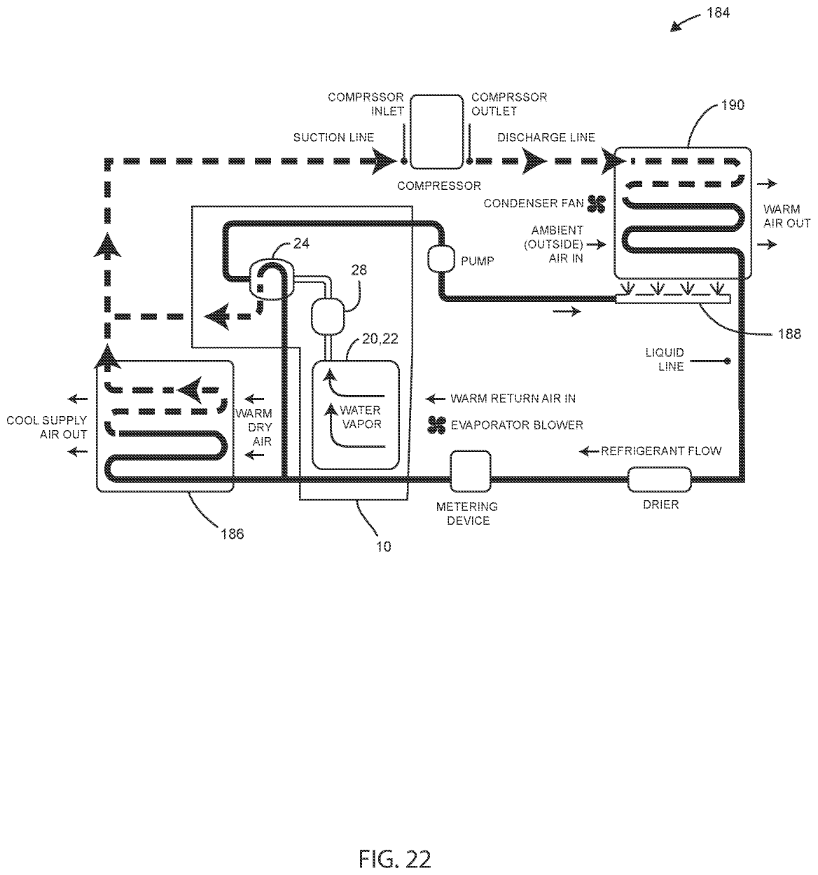

FIGS. 22-24 provide some example illustrations where an embodiment of a latent energy and water harvesting system is integrated into some air conditioning systems. For instance, FIG. 22 shows a conventional heating, air conditioning, and ventilation (HVAC) system 184 that is modified to integrate a latent energy and water harvesting system 10. Note that the energy and water harvesting system 10 depicted in these drawings may include all or a portion of the systems shown in FIGS. 1 and 19. The water vapor condenser 24 is connected to a parallel branch of the refrigerant line at an evaporator 186. The water vapor condenser 24 may also be connected in series with the evaporator 186 in some embodiments. The coated heat exchanging contactors 20 of the latent energy and water harvesting system 10 are placed in the airflow before the evaporator 186 to capture the water vapor. The benefit to the HVAC system 184 is a reduction of the cooling load on the evaporator 186 with the latent load removed. The water vapor is condensed and collected by the water vapor condenser 24 and, in this example, pumped to a spray bar 188 on a condenser 190 of the HVAC unit. Spraying the collected water on the outdoor condenser 190 aids in the condensation of the refrigerant as heat is removed by the evaporation of the water from the surface of the condenser coils. This is a further reduction of the load on the HVAC system 184. The liquid water from the water vapor condenser 24 is very pure and does not leave deposits on the condenser 190 that can reduce performance.

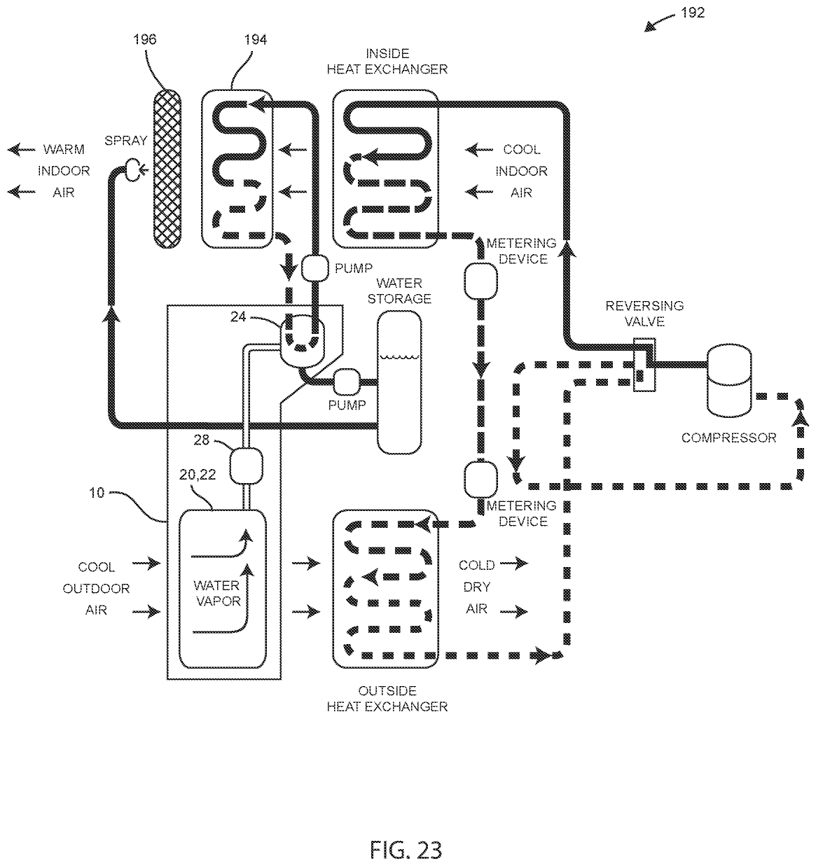

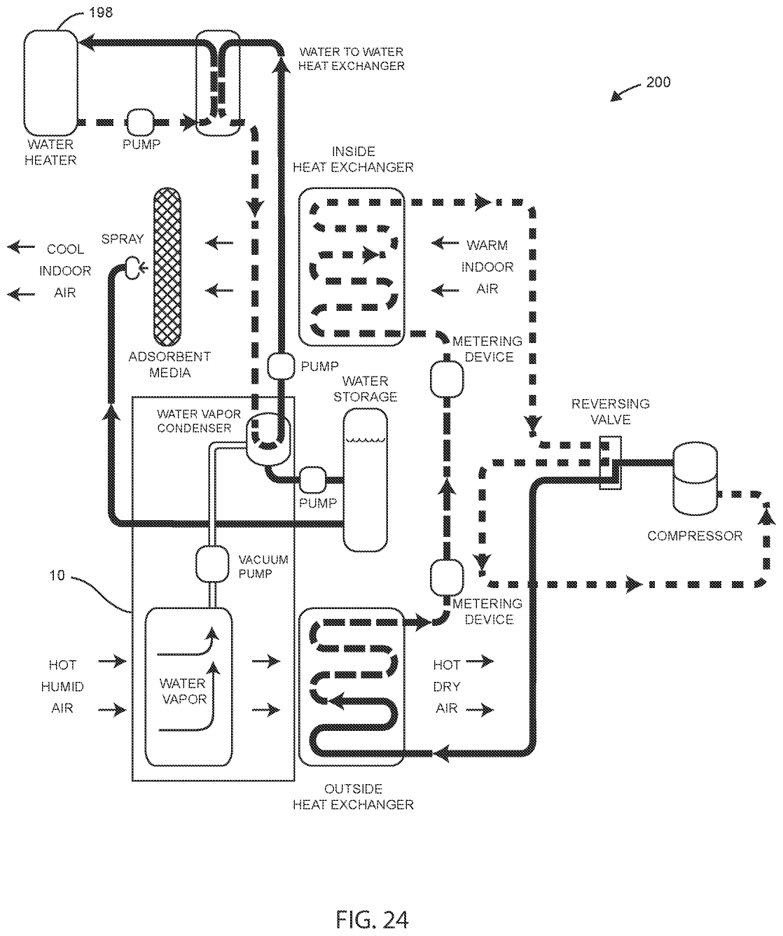

Another example of using captured latent energy is where the coolant source for the water vapor condenser is a heat pump system, as shown in FIG. 23. FIG. 23 shows a heat pump system 192 in which the latent energy and water harvesting system 10 is integrated. The heat pump system 192 comprises an air-source heat pump. Water vapor is captured from the outside air by the MOF coated heat exchanging contactors 20 of the latent energy and water harvesting system 10 and evacuated to the water vapor condenser 24 by the vacuum pump 28. As shown in FIG. 23, a water coil 194 in the indoor air stream moves heat from the water vapor condenser 24 to the indoor air. The water coil 194 provides the coolant source for the water vapor condenser 24. The liquid water harvested from the outside air may be used to supplement the humidity indoors by delivery to an adsorbent media 196 in the indoor air stream. In some applications, the heat from the water vapor condenser 24 may alternatively be used to assist the heating of a domestic water heater 198 as shown in the water heating system 200 of FIG. 24.

There are also many other examples of hydronic heating uses that may be integrated with a latent energy and water harvesting system, including circulating the coolant from the condenser through radiant heating panels, in-floor heating coils, and swimming pool heaters.

In view of the description above, it should be appreciated by one having ordinary skill in the art that one embodiment of a method of harvesting thermal energy and water from air, denoted as method 236 in FIG. 25 and performed by any one of the latent energy and water harvesting systems described herein, includes receiving a flow of water vapor containing air over a first heat exchanging contactor contained in a chamber in a non-sealed state, the heat exchanging contactor coated with an adsorbent material that adsorbs water vapor (238); desorbing water vapor from a second adsorbent-coated heat exchanging contactor contained in a chamber in a sealed state under a partial vacuum (240); exchanging thermal energy between the first heat exchanging contactor and the second heat exchanging contactor, wherein heat gained by heat of adsorption in the first heat exchanging contactor transferred to heat the second heat exchanging contactor to aid desorption, wherein heat lost due to the heat of desorption in the second heat exchanging contactor is transferred to cool the first heat exchanging contactor to aid adsorption (242); drawing a vacuum in the sealed chamber to pull air out and desorb, compress, and heat the water vapor (244); condensing water vapor in a condenser under a partial vacuum (246); recovering heat of condensation and liquid condensate from the water vapor in the condenser (248); and repeating the method with the first heat exchanging contactor used for desorbing in a sealed-state and the second heat exchanging contactor used for adsorbing in a non-sealed state (250). For instance, the thermal energy collected by the condenser may provide the source heat for a thermoelectric generator, a closed-loop rankine cycle or organic rankine cycle, a harmonic adsorption and recuperative power device, or other mechanism that converts heat to electrical power.

Some benefits of certain embodiments of a latent energy and water harvesting system include conditioning an air stream by removing water vapor, which reduces the energy used to condition the air, capturing and redirecting heat energy by condensing the water vapor outside of the air stream to supplement heating of air or water in many possible applications, and producing clean liquid water that also may be used in many ways. For instance, the clean water may be used for evaporative cooling by spraying on the condenser of an air conditioner, as previously described, sprayed on an adsorbent media to evaporatively cool an air stream, or the water may be used to cool electronic controls and battery packs in an electric vehicle.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the systems and methods have been described with reference to the example embodiments illustrated in the attached drawing figures, it is noted that equivalents may be employed and substitutions made herein without departing from the scope of the disclosure as protected by the following claims.

At least the following is claimed:

1. A latent energy and water harvesting system (10), comprising:
plural heat exchanging contactors (20), thermally coupled to enable thermal transfer, each heat exchanging contactor enclosed in a chamber (22), each chamber comprising a seal (62) surrounding an inlet and outlet of the chamber, each chamber capable of having a sealable state and a non-sealable state;
wherein the plural heat exchanging contactors are coated with an adsorbent material formulated to adsorb certain gas molecules in an air stream and desorb the same gas molecules under a partial pressure vacuum;
wherein the thermal transfer involves the exchange of heat of adsorption and heat of desorption between one of the plural heat exchanging contactors acting as an adsorbing heat exchanging contactor enclosed in the chamber in a non-sealed state and another of the plural heat exchanging contactors acting as a desorbing heat exchanging contactor in the chamber in a sealed state;
wherein the seal for the chamber in the sealed state allows a less than atmospheric pressure to be applied to the chamber while in the sealed state;
and wherein the chamber in the non-sealed state is open to atmospheric pressure to expose an airstream to each heat exchanging contactor;
a variable compression vacuum pump (28), wherein the partial pressure vacuum applied to the chamber in the sealed state is derived by the variable compression vacuum pump; and
a condenser (24) configured to collect thermal energy and liquid condensate from condensing gas molecules.

2. The latent energy and water harvesting system of claim 1, wherein the condenser is configured to condense gas molecules in the partial pressure vacuum.

3. The latent energy and water harvesting system of claim 1, wherein the variable compression vacuum pump compresses gas molecules to raise the pressure, allowing the gas molecules to condense in the condenser.

4. The latent energy and water harvesting system of claim 1, the system further comprising an auxiliary vacuum pump (234) to purge non-compressible gases from each chamber when in the sealed state in conjunction with the variable compression vacuum pump.

5. The latent energy and water harvesting system of claim 1, wherein the variable compression vacuum pump further comprises variable speed.

6. The latent energy and water harvesting system of claim 1, wherein the adsorbent material comprises one or more metal organic framework compounds.

7. The latent energy and water harvesting system of claim 1, further comprising one or more fluid-carrying conduits configured to enable the thermal transfer between heat exchanging contactors in one of the chambers and the another of the chambers.

8. The latent energy and water harvesting system of claim 7, further comprising a variable speed pump (18).

9. A latent energy and water harvesting system (10), comprising:
plural chambers (22) each comprising a heat exchanging contactor coated with an adsorbent material, and each having at least one pair of doors (38) configured to open and close, wherein the adsorbent material is formulated to adsorb gas molecules from an air stream;
a conduit connecting the plural chambers to enable thermal transfer by enabling transfer of heat of adsorption accumulated by the coated heat exchanging contactor of one open chamber to the coated heat exchanging contactor of one closed chamber to assist the desorption of the gas molecules and to enable transfer of heat of desorption to one open chamber to assist the adsorption of the gas molecules;
a condenser (24) configured to recover thermal energy and liquid condensate from condensation of the gas molecules in a partial vacuum within the condenser; and
a variable compression vacuum pump (28) configured to draw a partial vacuum within the chamber when the doors are closed, wherein the adsorbent material is formulated to desorb the gas molecules in the partial vacuum when the doors are closed, said variable compression vacuum pump compressing the gas molecules to a pressure sufficient to cause condensation to occur within the condenser.

10. The latent energy and water harvesting system of claim 9, further comprising one or more motive devices configured to open and close the doors.

11. The latent energy and water harvesting system of claim 10, further comprising a controller (16) and one or more sensors (36), the controller configured to actuate the one or more motive device to cause the doors to open or close based on input from the one or more sensors.

12. The latent energy and water harvesting system of claim 9, further comprising a means to adjust compression of the variable compression vacuum pump (162) to elevate the water vapor pressure sufficiently to condense inside the condenser.

13. The latent energy and water harvesting system of claim 9, wherein the conduit further comprises a variable speed pump (18).

14. A method (236) of harvesting thermal energy and water from air, the method comprising:
receiving a flow of water vapor containing air over a first heat exchanging contactor contained in a chamber in a non-sealed state, the first heat exchanging contactor coated with an adsorbent material that adsorbs water vapor (238);
desorbing water vapor from a second adsorbent-coated heat exchanging contactor contained in a chamber in a sealed state under a partial vacuum (240);
exchanging thermal energy between the first heat exchanging contactor and the second heat exchanging contactor, wherein heat gained by heat of adsorption in the first heat exchanging contactor transferred to heat the second heat exchanging contactor to aid desorption, wherein heat lost due to the heat of desorption in the second heat exchanging contactor is transferred to cool the first heat exchanging contactor to aid adsorption (242);
drawing a vacuum in the sealed chamber to pull air out and desorb, compress, and heat the water vapor (244);
condensing water vapor in a condenser under a partial vacuum (246);
recovering heat of condensation and liquid condensate from the water vapor in the condenser (248); and
repeating the method with the first heat exchanging contactor used for desorbing in a sealed-state and the second heat exchanging contactor used for adsorbing in a non-sealed state (250).

15. The method of claim 14, further comprising alternating a chamber from a non-sealed state to a sealed state while alternating another chamber from sealed state to a non-sealed state, sensing relative humidity, and alternating the two chambers again when the relative humidity in the chamber in a sealed state indicates desorption is complete.

16. The method of claim 15, further comprising adjusting a rate of the thermal energy exchange from the first adsorbent-coated heat exchanging contactor to the second adsorbent-coated heat exchanging contactor by varying the speed of a pump connected to the thermal conduits of the first and second adsorbent-coated heat exchanging contactors.

17. The method of claim 14, further comprising adjusting a partial pressure difference between the chamber in the sealed state and the condenser.

18. The method of claim 14, further comprising adjusting the rate of desorption from the chamber in the sealed state to the condenser.

19. The method of claim 14, wherein the desorbing is achieved at a coefficient of performance range of 10 to 20.

20. The latent energy and water harvesting system of claim 1, further comprising a controllable valve configured to enable drawing an equilibrium partial vacuum between a lower pressure and a higher pressure chamber(s) when the doors are closed to each of the chamber(s).

21. The latent energy and water harvesting system of claim 9, further comprising, a controllable valve configured to enable drawing an equilibrium partial vacuum between a lower pressure and a higher pressure chamber(s) when the doors are closed to each of the chamber(s).
